(19) United States
(12) Patent Application Publication
(10) Pub. No.: US 2024/0069907 A1
(43) Pub. Date: Feb. 29, 2024

(54) SOFTWARE DEVELOPMENT CONTEXT HISTORY OPERATIONS

(71) Applicant: Microsoft Technology Licensing, LLC, Redmond, WA (US)

(72) Inventors: Peter GROENEWEGEN, Sammamish, WA (US); Mark Alistair WILSON-THOMAS, Mercer Island, WA (US); German David OBANDO CHACON, Kirkland, WA (US); David Ellis PUGH, Redmond, WA (US); Mikhail BRESLAV, Redmond, WA (US); Oscar Alfonso OBESO TREJO, Redmond, WA (US)

(21) Appl. No.: 17/894,569

(22) Filed: Aug. 24, 2022

(51) Int. Cl. G06F 8/71; G06F 8/33; G06F 8/73

(52) U.S. Cl. CPC G06F 8/71; G06F 8/33; G06F 8/73

(57) ABSTRACT

Historic context data is automatically associated with particular pieces of source code by retrieval data structures. Ephemeral information is preserved, such as how a piece of code originated operationally and was changed over time, which research sources informed the code's origination and changes, and why particular changes in the code were made. Code may be rolled back to an earlier version based on parameters such as whether code had been refactored, or results of testing or static analysis. Rollback goes beyond editor undo actions, and a developer need not specify a timestamp or a version number. Developer documentation burdens are reduced, developer understanding is increased, and code quality is enhanced, by providing ready access to the code's software development context history data. Some actions made possible include highlighting code that was generated automatically by autocompletion or otherwise, highlighting refactored code, and highlighting pasted code, among other actions.

### BACKGROUND

Noon Many modern devices in a broad range of fields have some form of computing power, and operate according to software instructions that execute using that computing power. A few of the many examples of devices whose behavior depends on software include cars, planes, ships and other vehicles, robotic manufacturing tools and other industrial systems, medical devices, cameras, inventory management and other retail or wholesale systems, smartphones, tablets, servers, workstations and other devices which connect to the Internet.

The firmware, operating systems, applications and other software programs which guide various behaviors of these and many other computing devices is developed by people who may be known as developers, programmers, engineers, or coders, for example, but are referred to collectively here as “developers”. Developers may use source code editors, compilers, debuggers, profilers and various other software development tools as they develop software. Although many advances have been made, improvements in software development technologies are still possible.

### SUMMARY

Some embodiments described herein address technical challenges related to software development, such as how to increase consistency and event coverage when tracking source code changes, and how to determine which otherwise ephemeral software development contextual information to record. A related issue is how to meet these and other technical challenges without further burdening software developers.

To address these and other challenges, some embodiments automatically and proactively store particular kinds of software development contextual data for a given source code block, such as data representing the block's origin, data identifying other usage of the block's source code, or natural language descriptions of the block. Embodiments then retrieve and display that development context data to inform the subsequent development of software built using that source code block. These and other technical actions that preserve, organize, and present software development contextual data promote efficient and effective software development, by reducing developer documentation burdens, by surfacing helpful information at suitable times, and by capturing historic data that would otherwise be lost after a developer moved on to other work.

Other technical activities and characteristics pertinent to teachings herein will also become apparent to those of skill in the art. The examples given are merely illustrative. This Summary is not intended to identify key features or essential features of the claimed subject matter, nor is it intended to be used to limit the scope of the claimed subject matter. Rather, this Summary is provided to introduce—in a simplified form—some technical concepts that are further described below in the Detailed Description. The innovation is defined with claims as properly understood, and to the extent this Summary conflicts with the claims, the claims should prevail.

### DESCRIPTION OF THE DRAWINGS

A more particular description will be given with reference to the attached drawings. These drawings only illustrate selected aspects and thus do not fully determine coverage or scope.

FIG. 1 is a diagram illustrating aspects of computer systems and also illustrating configured storage media;

FIG. 2 is a diagram illustrating aspects of a computing system which has one or more of the software development context history (SDCH) enhancements taught herein;

FIG. 3 is a block diagram illustrating an enhanced system configured with SDCH functionality;

FIG. 4 is a block diagram illustrating some examples and aspects of SDCH data and SDCH data retrieval data structures (a.k.a. SDCH items);

FIG. 5 is a block diagram illustrating some aspects of source code and source code editing; and

FIG. 6 is a flowchart illustrating steps in some methods for SDCH creation or SDCH utilization.

### DETAILED DESCRIPTION

Overview

Innovations may expand beyond their origins, but understanding an innovation's origins can help one more fully appreciate the innovation. In the present case, some teachings described herein were motivated by technical challenges arising from ongoing efforts by Microsoft innovators to help software developers. Microsoft innovators conceived and explored various ways to effectively employ new kinds of data tracking to assist software development, and they considered broader questions such as how development tools can support source code editing and promote improved code quality.

The innovators recognized that the potential amount of data which could, in theory, be tracked, indexed, and subsequently retrieved during a software development project is enormous. Every keystroke can change the content of a source code file, so individually tracking each typed input to an editor could produce tens of thousands of individual snapshots for even a relatively short file holding a few hundred lines of code. Indeed, simply scrolling through a file without changing any of the source code is also a part of a development project's history, at least in theory, because scrolling indicates which parts of the file received the developer's interest.

Many other developer activities also could, in theory, be stored as corresponding data, indexed, and later retrieved, subject to appropriate privacy and security limitations. Potentially relevant developer activities include conversations with other members of the development team, browsing online software development forums, consulting programing language manuals, reading other source code, and so on. Compilation attempt results, build attempt results, static test results, behavior test results, performance measures, and debugging sessions, are each also a part of the development history that could, in theory, be represented as data that is stored, indexed, and later retrieved.

Thus, an initial technical challenge was how to narrow the scope of development history data by specifying a portion that is both helpful to development efforts and manageable in size. The innovators focused their attention on a collection of software development scenarios, and asked themselves what data would make development easier or produce better code in a given scenario. Some of these scenarios involve questions about a source code's development history that previously available data answers sporadically or not at all. Version control systems show snapshots of source code at different points in time, for example, but leave many questions unanswered, such as: where did a particular piece of code come from, what other information was the developer considering at the time, and where else is the same or similar code also in use.

Answers to questions like these about a source code's origins and other context can save development time and lead to better software. For example:

Knowing that a particular block of code was pasted in after being copied from another file or from an online forum allows a developer to look at the origin of the pasted code, see how the code was used there, compare the pasted version with the original, and consider any comments or discussion given in the pasted code's origin. Also, if an issue arises in the original code, the fix can be propagated to places that code was pasted into.

In some embodiments, a developer who is copying a block of code may also be given an opportunity to import related tests for use in testing the code that receives the pasted source code. This can be done recursively, so the history of the pasted code may be imported along with the pasted code. In the original code, in some embodiments contextual history data is created or amended to indicate that the code is being pasted elsewhere.

Knowing code origins may also facilitate licensing compliance.

Knowing that a particular block of code was generated automatically based on certain input to a code generator allows the developer to decide whether the generated code actually does what the input indicates was desired.

Knowing that a particular block of code was written in response to passing a particular test, or in response to a particular remark during a code review, helps the developer avoid degrading the code while modifying it.

Knowing that a particular block of code was rewritten during a security upgrade helps the developer avoid re-introducing a security vulnerability while modifying the code.

Knowing that certain edits were done automatically, e.g., by a refactoring tool, and that other edits were manual (e.g., received as keystrokes) allows a code reviewer to focus attention on the manual changes. This is especially helpful when the number of changes is large.

The foregoing examples are only a few of the many that will be apparent to one of skill in the software development art in view of the teachings provided herein.

Sometimes partial answers to questions about the origin of a source code block are provided in comments in the source code or in version control notes. But comments and notes do not reliably and consistently include answers to many relevant questions about the development context of source code, even when the comments and notes are generated automatically by a computing system. However, creating comments or notes manually (e.g., by typing or by speech dictation) takes time and effort that many developers would rather spend writing code to be executed, or debugging code, or writing unit tests, for example. For this and other reasons, manually created comments and notes also do not reliably and consistently indicate where a particular piece of code came from, what other information the developer considered, and where the same or similar code is also in use.

The innovators concluded it could be beneficial to integrate and coordinate particular kinds of software development context history (SDCH) into tools 130 that display source code 132. The SDCH 208 is associated with the corresponding source code, at the level of an individual block 134 of source code unless stated otherwise. A “block” is a statement in the programming language syntax sense, or a set of statements (e.g., a method, a type definition, a conditional statement body, a loop body, a class, or a portion thereof), or a set of contiguous lines of code, or a result of a command or a quick action such as a paste, a find-replace, or a refactor, or a result of an autocompletion or another automatic code generation. Although a block 134 could fill a file, e.g., the entire content of the file could have been pasted in all at once, in general a block will be smaller than the full file it resides in, because block size depends on editing operations, and editing operations typically effect less than an entire file. The SDCH associated with a block of source code can be retrieved and displayed, thereby providing data to answer questions like those noted above.

In some embodiments, SDCH can be used as a basis for rollback operations. For example, an SDCH-based rollback may show the source code as it existed the last time the code passed all unit tests, or it may show the source code as it existed the last time the code failed a particular static analysis test. SDCH-based rollback capabilities free developers of the burden of stepping back through code versions one by one, checking source code comments and version control system notes as they go, in the hope of finding the desired version of the code manually.

These and other benefits will be apparent to one of skill from the teachings provided herein.

Operating Environments

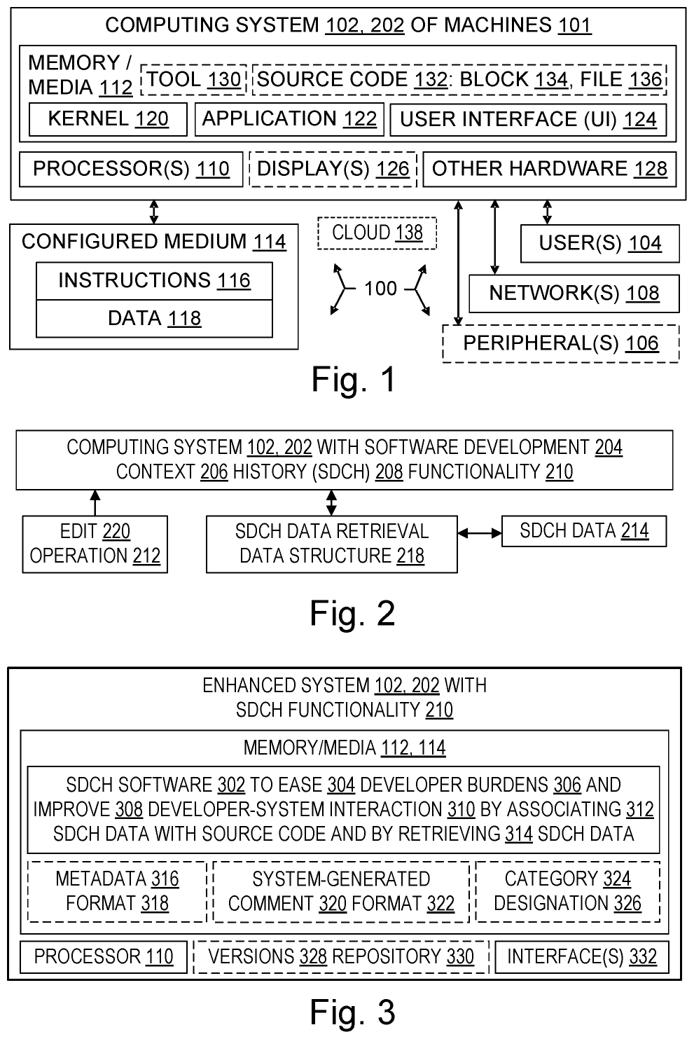

With reference to FIG. 1, an operating environment 100 for an embodiment includes at least one computer system 102. The computer system 102 may be a multiprocessor computer system, or not. An operating environment may include one or more machines in a given computer system, which may be clustered, client-server networked, and/or peer-to-peer networked within a cloud 138. An individual machine is a computer system, and a network or other group of cooperating machines is also a computer system. A given computer system 102 may be configured for end-users, e.g., with applications, for administrators, as a server, as a distributed processing node, and/or in other ways.

Human users 104 may interact with a computer system 102 user interface 124 by using displays 126, keyboards 106, and other peripherals 106, via typed text, touch, voice, movement, computer vision, gestures, and/or other forms of I/O. Virtual reality or augmented reality or both functionalities may be provided by a system 102. A screen 126 may be a removable peripheral 106 or may be an integral part of the system 102. The user interface 124 may support interaction between an embodiment and one or more human users. The user interface 124 may include a command line interface, a graphical user interface (GUI), natural user interface (NUI), voice command interface, and/or other user interface (UI) presentations, which may be presented as distinct options or may be integrated.

System administrators, network administrators, cloud administrators, security analysts and other security personnel, operations personnel, developers, testers, engineers, auditors, and end-users are each a particular type of human user 104. Automated agents, scripts, playback software, devices, and the like running or otherwise serving on behalf of one or more humans may also have accounts, e.g., service accounts. Sometimes an account is created or otherwise provisioned as a human user account but in practice is used primarily or solely by one or more services; such an account is a de facto service account. Although a distinction could be made, “service account” and “machine-driven account” are used interchangeably herein with no limitation to any particular vendor.

Storage devices and/or networking devices may be considered peripheral equipment in some embodiments and part of a system 102 in other embodiments, depending on their detachability from the processor 110. Other computer systems not shown in FIG. 1 may interact in technological ways with the computer system 102 or with another system embodiment using one or more connections to a cloud 138 and/or other network 108 via network interface equipment, for example.

Each computer system 102 includes at least one processor 110. The computer system 102, like other suitable systems, also includes one or more computer-readable storage media 112, also referred to as computer-readable storage devices 112. Applications 122 may include software apps on mobile devices 102 or workstations 102 or servers 102, as well as APIs, browsers, or webpages and the corresponding software for protocols such as HTTPS, for example.

Storage media 112 may be of different physical types. The storage media 112 may be volatile memory, nonvolatile memory, fixed in place media, removable media, magnetic media, optical media, solid-state media, and/or of other types of physical durable storage media (as opposed to merely a propagated signal or mere energy). In particular, a configured storage medium 114 such as a portable (i.e., external) hard drive, CD, DVD, memory stick, or other removable nonvolatile memory medium may become functionally a technological part of the computer system when inserted or otherwise installed, making its content accessible for interaction with and use by processor 110. The removable configured storage medium 114 is an example of a computer-readable storage medium 112. Some other examples of computer-readable storage media 112 include built-in RAM, ROM, hard disks, and other memory storage devices which are not readily removable by users 104. For compliance with current United States patent requirements, neither a computer-readable medium nor a computer-readable storage medium nor a computer-readable memory is a signal per se or mere energy under any claim pending or granted in the United States.

The storage device 114 is configured with binary instructions 116 that are executable by a processor 110; “executable” is used in a broad sense herein to include machine code, interpretable code, bytecode, and/or code that runs on a virtual machine, for example. The storage medium 114 is also configured with data 118 which is created, modified, referenced, and/or otherwise used for technical effect by execution of the instructions 116. The instructions 116 and the data 118 configure the memory or other storage medium 114 in which they reside; when that memory or other computer readable storage medium is a functional part of a given computer system, the instructions 116 and data 118 also configure that computer system. In some embodiments, a portion of the data 118 is representative of real-world items such as events manifested in the system 102 hardware, product characteristics, inventories, physical measurements, settings, images, readings, volumes, and so forth. Such data is also transformed by backup, restore, commits, aborts, reformatting, and/or other technical operations.

Although an embodiment may be described as being implemented as software instructions executed by one or more processors in a computing device (e.g., general purpose computer, server, or cluster), such description is not meant to exhaust all possible embodiments. One of skill will understand that the same or similar functionality can also often be implemented, in whole or in part, directly in hardware logic, to provide the same or similar technical effects. Alternatively, or in addition to software implementation, the technical functionality described herein can be performed, at least in part, by one or more hardware logic components. For example, and without excluding other implementations, an embodiment may include hardware logic components 110, 128 such as Field-Programmable Gate Arrays (FPGAs), Application-Specific Integrated Circuits (ASICs), Application-Specific Standard Products (ASSPs), System-on-a-Chip components (SOCs), Complex Programmable Logic Devices (CPLDs), and similar components. Components of an embodiment may be grouped into interacting functional modules based on their inputs, outputs, and/or their technical effects, for example.

In addition to processors 110 (e.g., CPUs, ALUs, FPUs, TPUs, GPUs, and/or quantum processors), memory/storage media 112, peripherals 106, and displays 126, an operating environment may also include other hardware 128, such as batteries, buses, power supplies, wired and wireless network interface cards, for instance. The nouns “screen” and “display” are used interchangeably herein. A display 126 may include one or more touch screens, screens responsive to input from a pen or tablet, or screens which operate solely for output. In some embodiments, peripherals 106 such as human user I/O devices (screen, keyboard, mouse, tablet, microphone, speaker, motion sensor, etc.) will be present in operable communication with one or more processors 110 and memory 112.

In some embodiments, the system includes multiple computers connected by a wired and/or wireless network 108. Networking interface equipment 128 can provide access to networks 108, using network components such as a packet-switched network interface card, a wireless transceiver, or a telephone network interface, for example, which may be present in a given computer system. Virtualizations of networking interface equipment and other network components such as switches or routers or firewalls may also be present, e.g., in a software-defined network or a sandboxed or other secure cloud computing environment. In some embodiments, one or more computers are partially or fully “air gapped” by reason of being disconnected or only intermittently connected to another networked device or remote cloud. In particular, SDCH functionality 210 could be installed on an air gapped network and then be updated periodically or on occasion using removable media 114. A given embodiment may also communicate technical data and/or technical instructions through direct memory access, removable or non-removable volatile or nonvolatile storage media, or other information storage-retrieval and/or transmission approaches.

One of skill will appreciate that the foregoing aspects and other aspects presented herein under “Operating Environments” may form part of a given embodiment. This document's headings are not intended to provide a strict classification of features into embodiment and non-embodiment feature sets.

One or more items are shown in outline form in the Figures, or listed inside parentheses, to emphasize that they are not necessarily part of the illustrated operating environment or all embodiments, but may interoperate with items in the operating environment or some embodiments as discussed herein. It does not follow that any items which are not in outline or parenthetical form are necessarily required, in any Figure or any embodiment. In particular, FIG. 1 is provided for convenience; inclusion of an item in FIG. 1 does not imply that the item, or the described use of the item, was known prior to the current innovations.

More About Systems

FIG. 2 illustrates a computing system 102 configured by one or more of the software development context history enhancements taught herein, resulting in an enhanced system 202. This enhanced system 202 may include a single machine, a local network of machines, machines in a particular building, machines used by a particular entity, machines in a particular datacenter, machines in a particular cloud, or another computing environment 100 that is suitably enhanced. FIG. 2 items are discussed at various points herein, and additional details regarding them are provided in the discussion of a List of Reference Numerals later in this disclosure document.

FIG. 3 illustrates an enhanced system 202 which is configured with software development context history (SDCH) software 302 to provide SDCH functionality 210. Software 302 and other FIG. 3 items are discussed at various points herein, and additional details regarding them are provided in the discussion of a List of Reference Numerals later in this disclosure document.

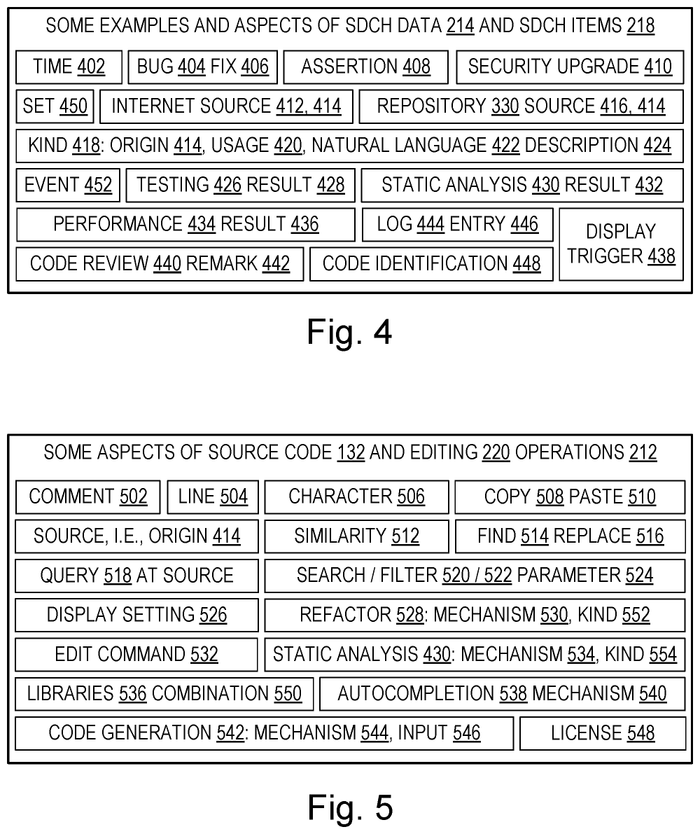

FIG. 4 shows some examples and some aspects of SDCH data 214 and SDCH items 218. “SDCH item” is a shorter alias herein for “SDCH data retrieval data structure”. For instance, an SDCH data retrieval data structure 218 which includes pointers, indexes, sizes, or other digital value(s) identifying a block 134 of source code together with an associated linked list, array, table, or other digital value(s) identifying a list of one or more web pages 412 is an example of an SDCH item 218. The digital values in the data structure are examples of SDCH data 214. A web page identified by one of the digital values is an aspect of the SDCH item 218, and is also an aspect of the SDCH data 214, and in some embodiments may also be SDCH data 214. FIG. 4 items are discussed at various points herein, and additional details regarding them are provided in the discussion of a List of Reference Numerals later in this disclosure document.

FIG. 5 shows some aspects of source code 132 and source code editing 220. FIG. 5 items are discussed at various points herein, and additional details regarding them are provided in the discussion of a List of Reference Numerals later in this disclosure document.

FIGS. 4 and 5 are not comprehensive, in the sense that other specific examples and other specific aspects pertinent to SDCH may well also become apparent to one of skill who is informed by the teachings provided herein. In the context of FIGS. 4 and 5, an “example” is presumptively part of at least one embodiment, whereas an “aspect” is not presumptively part any embodiment, but is nonetheless identified by, accessed by, or otherwise functionally related to at least one embodiment.

FIGS. 1 through 5 are not themselves a complete summary of all approaches to software development context history tracking or utilization. Nor are they a complete summary of all aspects of an environment 100 or system 202 or other computational context of source code 132, whether the source code is under development or not. FIGS. 1 through 5 are also not by themselves a complete summary of all SDCH data 214, SDCH items 218, SDCH software 302, enhanced systems 202, enhanced tools 130, other mechanisms, or other SDCH functionalities 210 suitable for potential use in a system 202.

In some embodiments, the enhanced system 202 may be networked through an interface 332. An interface 332 may include hardware such as network interface cards, software such as network stacks, APIs, or sockets, combination items such as network connections, or a combination thereof.

In some embodiments, an enhanced system 202 includes a computing system 202 which is configured to facilitate source code development by helping improve a source code. The enhanced system 202 includes a digital memory 112 and a processor 110 in operable communication with the memory. In a given embodiment, the digital memory 112 may be volatile or nonvolatile or a mix. The enhanced system 202 also includes a software development tool 130 having a graphical user interface 124. The enhanced system 202 also includes at least one processor 110 in operable communication with the digital memory 112. The at least one processor is configured to collectively perform software development context history (SDCH) operations including: receiving 602 an edit operation 212 via the graphical user interface 124, automatically and proactively identifying 604 an edited source code 132 produced 220 by the edit operation 212, automatically and proactively generating 606 an SDCH data retrieval data structure 218 specifying SDCH data 214 which extends beyond the edited source code and also extends beyond any human-made comment 502 in the edited source code, and automatically and proactively associating 312 the SDCH data 214 with the edited source code using the SDCH data retrieval data structure 218.

Some embodiments store 608 an SDCH data retrieval data structure 218 (a.k.a. an SDCH item 218) or SDCH data 214 only in volatile memory 112. However, in some embodiments an SDCH item 218 or SDCH data 214 or both are also or instead stored 608 in non-volatile memory 112.

In some embodiments, the system 202 is configured to store 608 the SDCH data 214 in at least one of the following formats: a metadata format 318 external to any comment 502 in the edited source code 132, or a comment format 322 within a system-generated source code comment 320 in the edited source code 132. System-generated comments 320, like human-created comments, are delimited per a programming language syntax and are viewable as text inside a source code file 136 (in some cases, a tool 130 may automatically hide or reformat such comments). Metadata 316 may be embedded in the source code file, e.g., using techniques like those used to store text appearance control data in a .docx file. Metadata 316 may also be kept in a separate file, similar to what is done for example with debugging data kept in a .pdb file. Metadata 316 may also be kept in a database, or be accessed via a service API. Mixtures of the foregoing storage 608 approaches may also be used in a given embodiment.

Some embodiments include a version-controlled repository 330, and the system 202 is configured to store 608 the SDCH data and the edited source code 132 coordinated together in the version-controlled repository. Such coordination would be a beneficial side-effect of using a system-generated comment format 322 with a typical repository 330. Coordination could also be implemented by enhancing the repository to include metadata 316 as well as source code text within the scope of version control management.

Different kinds 418 of development context data 214 may be helpful over the course of a lifespan of a given piece of source code, e.g., a particular source code block 134 or file 136. In some embodiments, an SDCH item 218 includes data 214 representing or indicating at least one of the following: an origin 414 of a piece of source code (e.g., was it pasted in, created by a refactor, part of a template fill, etc.), a usage 420 of another instance of the piece of source code (e.g., usage elsewhere in the same codebase, or in a code generator's training data), or a natural language 422 description 424 of the software item (e.g., a link to library documentation). In some embodiments, SDCH data 214 includes data 118, 214 representing or indicating at least one of the following: an origin 414 of an edited source code, or a natural language description 424 of the edited source code.

One of skill informed by the teachings of the present disclosure will acknowledge that embodiments may be selected and configured to provide various technical benefits. For example, SDCH functionality 210 as described herein eases 304 the burden on human developers to manually create comments 502 that include origin 414 information such as which websites 412 a developer learned from or even copied code from, which file 136 a pasted block 134 was copied from, whether a block has been refactored, and so on. An enhanced system 202 can automatically and proactively generate SDCH data 214 capturing such origin 414 information, and automatically and proactively associate 312 that data 214 with the source code so it can be retrieved 314 later. The ready availability of SDCH data 214 results in more effective development by bringing a new developer up to speed more quickly and thoroughly, by helping developers avoid re-introducing undesired defects or deficiencies, and by preserving helpful information that would otherwise be lost.

These example scenarios are illustrative, not comprehensive. One of skill informed by the teachings herein will recognize that many other scenarios and many other variations are also taught. In particular, different embodiments or configurations may vary as to the number or precise workings of the SDCH items 218, and SDCH software 302, for example, and yet still be within the scope of the teachings presented in this disclosure.

Other system embodiments are also described herein, either directly or derivable as system versions of described processes or configured media, duly informed by the extensive discussion herein of computing hardware.

Although specific SDCH architecture examples are shown in the Figures, an embodiment may depart from those examples. For instance, items shown in different Figures may be included together in an embodiment, items shown in a Figure may be omitted, functionality shown in different items may be combined into fewer items or into a single item, items may be renamed, or items may be connected differently to one another.

Examples are provided in this disclosure to help illustrate aspects of the technology, but the examples given within this document do not describe all of the possible embodiments. For example, a given embodiment may include additional or different data structure implementations of SDCH data 214 or SDCH items 218 as well as different technical features, aspects, security controls, mechanisms, decision criteria, expressions, hierarchies, operational sequences, environment or system characteristics, or other SDCH functionality teachings noted herein, and may otherwise depart from the particular illustrative examples provided.

Processes (a.k.a. Methods)

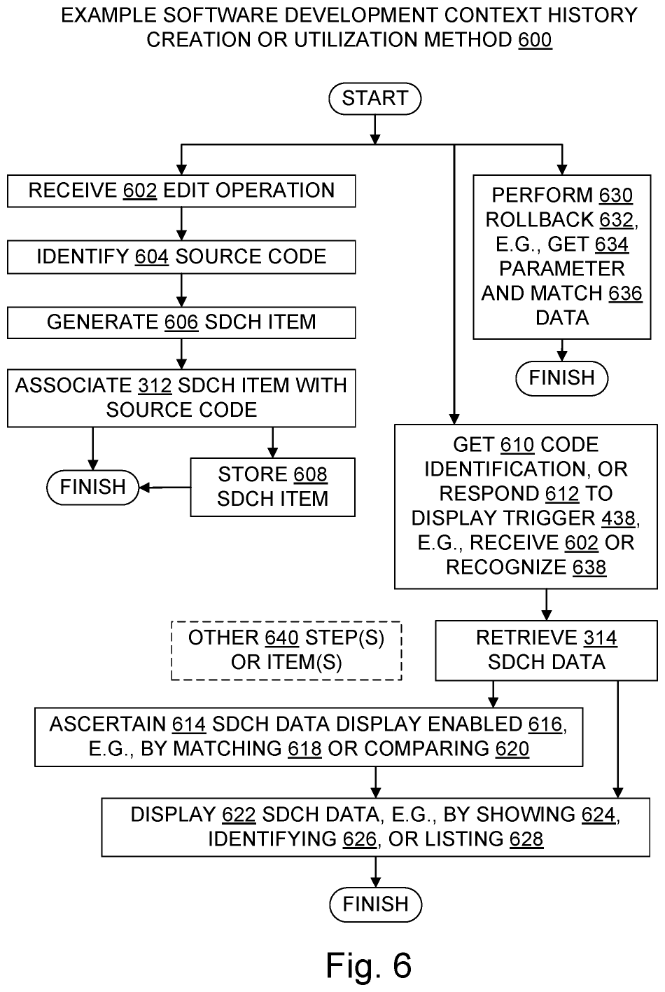

Methods (which may also be referred to as “processes” in the legal sense of that word) are illustrated in various ways herein, both in text and in drawing figures. FIG. 6 illustrates a family of methods 600 that may be performed or assisted by an enhanced system, such as system 202 or another SDCH functionality enhanced system as taught herein. FIG. 6 also illustrates three families of methods 600 in the sense that FIG. 6 includes three FINISH points which can each be reach by a START-FINISH path that does not overlap any START-FINISH path to a different FINISH point. FIGS. 1 through 5 show SDCH architectures with implicit or explicit actions, e.g., steps for collecting data, transferring data, storing data, and otherwise processing data.

Technical processes shown in the Figures or otherwise disclosed will be performed automatically, e.g., by an enhanced system 202, unless otherwise indicated. Related processes may also be performed in part automatically and in part manually to the extent action by a human person is implicated, e.g., in some embodiments a human 104 may type in a value for the system 202 to use as a search parameter 524. But no process contemplated as innovative herein is entirely manual or purely mental; none of the claimed processes can be performed solely in a human mind or on paper. Any claim interpretation to the contrary is squarely at odds with the present disclosure.

In a given embodiment zero or more illustrated steps of a process may be repeated, perhaps with different parameters or data to operate on. Steps in an embodiment may also be done in a different order than the top-to-bottom order that is laid out in FIG. 6. Steps from different START-FINISH paths may also be combined, e.g., an example method EG1 includes steps 602, 604, 606, 312, and 630, an example method EG2 includes steps 602, 604, 606, 312, 612, 314 and 622, and an example method EG3 includes steps 610, 314, and 630. Many other examples methods are also represented by FIG. 6.

Arrows in method or data flow figures indicate allowable flows; any arrows pointing in more than one direction thus indicate that flow may proceed in more than one direction. Steps may be performed serially, in a partially overlapping manner, or fully in parallel within a given flow. In particular, the order in which flowchart 600 action items are traversed to indicate the steps performed during a process may vary from one performance of the process to another performance of the process. The flowchart traversal order may also vary from one process embodiment to another process embodiment. Steps may also be omitted, combined, renamed, regrouped, be performed on one or more machines, or otherwise depart from the illustrated flow, provided that the process performed is operable and conforms to at least one claim.

Some embodiments provide or utilize a software development method 600, the method being performed (executed) by a software development tool 130 having a graphical user interface 124 and running on a computing system 202, the method including: getting 610 via the graphical user interface an identification 448 of an edited source code block 134; retrieving 314 a software development context history (SDCH) data 214 by using an SDCH item 218 that is associated with the edited source code block, the SDCH data 214 being additional to the edited source code block and also being additional to any human-made comment 502 that is located in the edited source code block or is located within five lines 504 or two hundred characters 506 or both of any part of the edited source code block; and displaying 622 the SDCH data in the graphical user interface. Recall that for convenience, an SDCH data retrieval data structure 218 is also referred to herein as an SDCH item 218.

In some embodiments, the method includes ascertaining 614 that the SDCH data is enabled 616 for display prior to displaying 622 the SDCH data in the graphical user interface. In some, the ascertaining 614 is based on at least one of: matching 618 a search 520 parameter 524 to the SDCH data or to a category designation 326 of the SDCH data; comparing 620 a code review 440 filter 522 to the SDCH data or to a category designation 326 of the SDCH data; or comparing 620 an SDCH data display setting 526 to the SDCH data or to a category designation 326 of the SDCH data. For instance, in some embodiments SDCH data that matches 618 a search parameter, or that satisfies a filter 522, and that is not contrary to a display setting 526, will be enabled 616 and hence displayed 622. In some, display settings 526 are not used, so whether SDCH data is displayed depends on search 520 results or filter 522 results, or both.

For instance, in some embodiments a search 520 mechanism 302 utilizes SDCH functionality 210 to display 622 all portions of a source code 134 that were placed in a file 136 by pasting 510, or all portions that have been refactored 528, or all portions that were changed by at least one find-replace 516 operation, or all portions that were placed in the file by autocompletion 538, or all code in the file that was generated 542 automatically. A given embodiment may support further refinements or combinations, e.g., to display 622 results of a search for code that was pasted 510 after being copied from a web page 412, or code that was refactored 528 after a specified static analysis test 430, or code that passed a specified set of unit tests 426 and was also flagged 442 during a code review 440. These are examples; a given embodiment may also or instead provide or utilize other or additional SDCH search 520 or filter 522 functionality 210.

In some embodiments, display settings 526 visually highlight code from internet sources 412 by default, and visually highlight code from a repository source 416 only in response to a specific command to do so. In some embodiments, a category-specific display setting 526 specifies that by default the tool shows a “pasted” 510 pop-up or a “generated” 542 pop-up when a cursor is located in, or hovers over, pasted code or generated code, respectively. These are examples; a given embodiment may also or instead provide or utilize other or additional SDCH display 622 functionality 210.

In some embodiments, displaying 622 the SDCH data includes showing 624 or identifying 626 at least one of: an assertion 408 that the edited source code block resulted at least in part from a paste 510; a particular source 414 that at least a part of the edited source code block was copied from before being pasted 510 in; a particular internet source 412 that at least a part of the edited source code block was copied from before being pasted 510 in; a particular repository source 416 that at least a part of the edited source code block was copied from before being pasted 510 in; a query 518 submitted to a source 414 of at least a part of the edited source code block; an assertion 408 that at least a part of the edited source code block resulted from a find-replace 516; an assertion 408 that at least a part of the edited source code block resulted from a refactor 528; an assertion 408 that at least a part of the edited source code block resulted from a specified kind of refactor 528; or a particular refactoring mechanism 530 that produced at least a part of the edited source code block.

With regard to pasting, knowing where a given piece of pasted code originated can help a developer spot potential licensing 548 issues, e.g., in some environments code pasted after being copied from an internal repository 330 was vetted for licensing purposes when placed in the internal repository, whereas code from other sources 414 is not known to have been vetted. By automatically and proactively tracking the source 414 of pasted code, an embodiment retains origin data that is otherwise often lost when the paste is done. In theory, a developer could be instructed to document the sources 414 of pasted code 132 in comments near the pasted code, but in practice this would place a substantial additional burden 306 on the developer, and the likelihood of consistent compliance with the instruction is very small.

Knowing where a given piece of pasted code was copied from has other benefits as well. If the code came from a repository, then the name(s) of developers associated with the code in the repository can be automatically extracted and made part of the SDCH data which is associated 312 with the pasted code, thereby providing the developer of the pasted code's recipient file with a source 414 of information about the pasted code's intended functionality, completeness (or lack thereof), alternatives, bugs, and so on. If the pasted code came from an online forum 412, then the URL of the forum can be made part of the SDCH data associated with the pasted code, thereby providing the developer of the pasted code's recipient file with a link to forum discussion of the pasted code as to functionality, completeness, alternatives, bugs, and so on. Different URLs may also have different reputations, leading, e.g., to different levels of scrutiny during a code review. Knowing the web search query 518 or in-page string search query 518 that led to the online source 412, via SDCH operations, will also inform subsequent developers about the technical goals of the developer who made that query and then pasted in code from the query's results.

In some embodiments, displaying 622 the SDCH data includes showing 624 at least one of: an assertion 408 that a copy of at least a part of the edited source code block is used elsewhere, or an assertion 408 that code deemed similar 512 to at least a part of the edited source code block is used elsewhere. For example, the SDCH data shown in an enhanced tool may assert that a particular block of code is also used elsewhere in a company codebase, even though no build dependency exists between the two instances of the code. As to other uses of similar code, the SDCH data shown in the enhanced tool may assert, e.g., that a particular block of code was copied from elsewhere, pasted in here, and then edited. This may include, e.g., an assertion that code was pasted from a repo 330 or from an online forum 412, or from a project that the current project was created from.

In some embodiments, the method includes performing 630 a targeted code history rollback 632. Such a rollback may include getting 634 a non-version-control search parameter 524 (one which specifies neither a particular time nor a particular source code control version), and matching 636 the SDCH data to the non-version-control search parameter. For example, an embodiment may rollback edits to show an earlier version 328 of an individual block 134, or an earlier version of an entire file 136, just prior to a specified static analysis 430, or prior to a specified refactoring 528, or prior to a specified pasting 510, or prior to a specified find-replace 516. In some embodiments, a developer may command an enhanced system 202 to rollback directly to a point where a selected piece of code 132 first came into a file, without showing all the intervening edits.

Some earlier code versions may also be available through an editor undo feature, but only if the refactoring/pasting/replacing was performed in the current editing session. By contrast, SDCH data-based rollbacks are not limited to undoing operations 212 from the current edit session. Moreover, SDCH data-based rollbacks 632 can provide versions from a development history that is not specified in terms of editing operations, e.g., versions 328 specified in terms of static analysis 430, testing 426, review remarks 442, or performance 434 events such as exceptions or hangs.

Some earlier code versions may also be available through a version control system 330. But without SDCH data 214 memorializing events such as static analysis 430, testing 426, review remarks 442, or performance 434 events, and without SDCH items 218 that associate 312 SDCH data 214 with particular pieces of code 132, manually trying to find the desired version is tedious and time-consuming, and whether the desired version can be identified depends on whether a developer had the foresight and took the time to document the desired event in a note or comment. Many developers do not routinely and consistently write comments that document events such as static analysis 430, testing 426, code review remarks 442, or performance 434 results.

By contrast, SDCH data may be reliably and consistently stored with code in a version control system 330 along with corresponding version numbers or timestamps. This allows an enhanced system 202 to match an SDCH search or filter criterion with a corresponding version number or other value that can be fed into the version control system to identify the desired version.

In short, SDCH functionality improves the availability and consistency of earlier code versions, and relieves developers of a documentation burden.

In some embodiments, the method displays data of an SDCH set 450 inside an editor development tool 130 which is displaying a source code 132 that includes the edited source code block. The SDCH set includes at least one SDCH item 218. The displayed data 214 of the SDCH set indicates at least N of the following software item lifecycle events 452: an origin 414 of the edited source code block; a bug fix 406 associated with the edited source code block; a security upgrade 410 associated with the edited source code block; a testing result 428 associated with the edited source code block; a performance result 436 associated with the edited source code block; or a log entry 446 associated with an execution of an executable code that was derived from the edited source code block. In a given embodiment or circumstance, N may be in the range from one to six.

In some embodiments, displaying 622 the SDCH data includes listing 628 a software libraries combination 550 which includes at least two software libraries 536 that the edited source code block utilizes. The block may utilize a library, e.g., by calling an API of the library, or by importing a class or other data structure definition of the library. In some of these embodiments, displaying 622 the SDCH data also includes specifying 408 at least one of: another usage 420 of the software libraries combination, or a natural language description 424 of the software libraries combination. Knowing that a combination 550 of libraries is used in a particular piece of code is helpful because libraries may interact in unexpected or undesired ways. Looking at other places the same combination is used (possibly as part of a larger set of libraries), or places that describe the combination (e.g., documentation or forum postings) may provide a developer time-saving insight into how the libraries interact with each other.

In some embodiments, displaying 622 the SDCH data occurs in response to at least one of the following display triggers 438: receiving 602 an edit operation which is directed at the edited source code block; or recognizing 638 a testing failure result 428 associated with the edited source code block.

For example, when editing 220 moves a cursor into a block 134 or otherwise targets it, some embodiments proactively display in response one or more of the following kinds of SDCH data 214: origin 414, usage 420, natural language description 424. For instance, an enhanced tool may proactively inform a developer that the block just selected in the editor was pasted in from an online contoso developers' forum discussion and then refactored, that similar code is also used in an internal project named nashirien, and that the selected block failed unit test 99612C43.

In some embodiments, displaying 622 the SDCH data includes showing or identifying at least one of: an assertion 408 that at least a part of the edited source code block was suggested by an autocompletion mechanism 540; a particular autocompletion mechanism 540 that produced at least a part of the edited source code block; an assertion that at least a part of the edited source code block was suggested by a code generation mechanism 544; a particular code generation mechanism 544 that produced at least a part of the edited source code block item; an assertion 408 that at least a part of the edited source code block resulted from providing a specified input 546 to a code generation mechanism, the assertion displayed together with a copy of the specified input; or an assertion 408 that at least a part of the edited source code block resulted from providing a specified natural language description 424 as input 546 to a code generation mechanism 544, the assertion displayed together with a copy of the specified natural language description. Proper subsets of these data may also be present, e.g., some embodiments omit autocompletion 538 SDCH data, some omit code generation 542 SDCH data, some omit input 546 SDCH data, and so on, consistent with the “at least one of” language above.

For example, an enhanced tool may inform 622 a developer that a regular expression in a block 134 of code was generated by a GPT-3 based regex generator 544 from the natural language description input “find a double slash comment” combined with this example of a matching string as additional input: “// Hello world is the best program ever\n” 546. Knowing that a regex or other code was generated 542, knowing which generator 544 produced the code, and knowing the input 546 given to the generator, can each help a developer assess the likely correctness of the generated code.

In some embodiments, displaying 622 the SDCH data includes showing or identifying at least one of: an assertion 408 that at least a part of the edited source code block resulted from a static analysis mechanism 534; an assertion that at least a part of the edited source code block resulted from a specified static analysis result 432; a particular static analysis mechanism 534 that produced at least a part of the edited source code block; a particular editor command 532 that produced at least a part of the edited source code block; an assertion 408 that at least a part of the edited source code block resulted from a specified code review 440; or an assertion 408 that at least a part of the edited source code block resulted from a specified testing result 428. Proper subsets of these data may also be present, e.g., some embodiments omit static analysis 430 SDCH data, some omit particular command 532 SDCH data, some omit code review 440 SDCH data, some omit testing 426 SDCH data, and so on, consistent with the “at least one of” language above. Moreover, the groupings in the claims and the specification paragraphs are not exclusive of one another, e.g., an embodiment may include both code generation 542 SDCH data and particular editor command 532 SDCH data.

In addition to knowing that certain development history events 452 occurred for a given block of code, it may also be helpful to know that certain events did not occur. Accordingly, in some embodiments, displaying 622 the SDCH data includes showing or identifying at least one of: an assertion 408 that at least a part of the edited source code block was produced without any pasting 510; an assertion 408 that at least a part of the edited source code block was produced without any find-replace 516; an assertion 408 that at least a part of the edited source code block was produced without any refactoring 528; an assertion 408 that at least a part of the edited source code block was produced without any autocompletion 538; an assertion 408 that at least a part of the edited source code block was produced without any code generation 542; or an assertion 408 that at least a part of the edited source code block was produced without any static analysis 430.

Configured Storage Media

Some embodiments include a configured computer-readable storage medium 112. Storage medium 112 may include disks (magnetic, optical, or otherwise), RAM, EEPROMS or other ROMs, and/or other configurable memory, including in particular computer-readable storage media (which are not mere propagated signals). The storage medium which is configured may be in particular a removable storage medium 114 such as a CD, DVD, or flash memory. A general-purpose memory, which may be removable or not, and may be volatile or not, can be configured into an embodiment using items such as SDCH data structures 218, SDCH data 214, metadata 316, system-generated comments 320, and SDCH software 302, in the form of data 118 and instructions 116, read from a removable storage medium 114 and/or another source of data such as a network connection, to form a configured storage medium. The configured storage medium 112 is capable of causing a computer system 102 to perform technical process steps 600 for SDCH creation or utilization, as disclosed herein. The Figures thus help illustrate configured storage media embodiments and process (a.k.a. method) embodiments, as well as system and process embodiments. In particular, any of the process steps illustrated in FIG. 6 or otherwise taught herein, may be used to help configure a storage medium to form a configured storage medium embodiment.

Some embodiments use or provide a computer-readable storage device 112, 114 configured with data 118 and instructions 116 which upon execution by at least one processor 110 cause a computing system to perform a software development method 600. This method 600 includes: receiving 602 an edit operation via a software development tool user interface; identifying 604 a source code block targeted by the edit operation, the source code block being in a source code file; generating 606 a software development context history (SDCH) data retrieval data structure specifying data which extends beyond the source code block and also extends beyond any human-made comment in the source code file; associating 312 the SDCH data with the source code block using the SDCH data retrieval data structure; retrieving 314 the SDCH data using the SDCH data retrieval data structure; and displaying 622 the SDCH data in the software development tool user interface.

In some embodiments, displaying 622 the SDCH data includes showing or identifying at least one of: a particular internet source 412 that at least a part of the source code block was copied from into the source code file; or a query 518 submitted to a source 414 of at least a part of the source code block, the source 414 external to the source code 132 file 136.

In some embodiments, displaying 622 the SDCH data includes showing or identifying at least one of: an assertion 408 that at least a part of the source code block resulted from a specified static analysis result 432; or an assertion 408 that at least a part of the source code block resulted from a specified testing result 428.

In some embodiments, displaying 622 the SDCH data includes showing or identifying at least one of: an assertion 408 that at least a part of the source code block resulted from a specified kind 552 of refactor 528; or an assertion 408 that at least a part of the source code block resulted from a specified code review remark 442.

In some embodiments, displaying 622 the SDCH data includes showing or identifying an assertion 408 that at least a part of the source code block resulted from a specified kind 554 of static analysis 430.

In some embodiments, displaying 622 the SDCH data includes showing or identifying at least one of: an assertion 408 that at least a part of the source code block resulted from a refactor 528; or an assertion 408 that at least a part of the source code block resulted from providing a specified input 546 to a code generation mechanism 544, the assertion displayed together with a copy of the specified input.

Additional Observations

Additional support for the discussion of SDCH functionality 210 herein is provided under various headings. However, it is all intended to be understood as an integrated and integral part of the present disclosure's discussion of the contemplated embodiments.

One of skill will recognize that not every part of this disclosure, or any particular details therein, are necessarily required to satisfy legal criteria such as enablement, written description, or best mode. Any apparent conflict with any other patent disclosure, even from the owner of the present innovations, has no role in interpreting the claims presented in this patent disclosure. With this understanding, which pertains to all parts of the present disclosure, examples and observations are offered herein.

One of skill understands there are significant technical benefits to the teachings and embodiments discussed herein. For example, an alternative would be an ad hoc approach relying on developers to track code blocks' respective origins in comments 502.

By contrast, associating 312 a software development context history (SDCH) item with a code block that has been selected for an insertion into a source code supports automatically tracking origin 414, usage example 420, human-readable description 424, and other SDCH data 214 on a per-code-block basis. This provides benefits such as: more consistent tracking than developer comments, information retrieval via new indexes or structures, reduced burden on developers to provide input as comments, and more efficient and effective software development by providing developers with relevant information about code 132 when they are editing that code. SDCH data may also be analyzed across projects for insights into development trends or other patterns or characteristics, e.g., how much code is written “from scratch”, which changes tend to be made by a given user (and perhaps then add them proactively and automatically to paste operations). SDCH data may be used as training data to train a machine learning model.

In some embodiments, the software development context history (SDCH) item effectively includes (i.e., contains, identifies, or gives access to) data 214 representing or indicating at least one of the following: an origin of the instance of the software item, a usage of another instance of the software item, or a natural language description of the software item. This functionality 210 supports particular kinds of software development context history storage 608 and retrieval 314, including software item origin 414 (e.g., pasted, from refactor, template filled in), software item usage 420 elsewhere (e.g., elsewhere in this codebase, or in generator training data), or software item natural language description 424 (e.g., link to library documentation). These data 214 in turn provide benefits noted above upon their retrieval 314.

The innovators observed that after a block of code is inserted into a code base, it becomes hard to determine later how the code got there. For example, the block of code could have been inserted by a copy-paste 510 operation, by accepting an artificial intelligence (AI) suggestion 542, or in other ways. Some embodiments described here associate metadata 316, 214 with the block of code to indicate how the code got there. The metadata can also indicate examples of usage 420, a human readable description 424 of what the code does, or other information such as static analysis results 432 or behavior testing results 428 or performance results 436. The metadata may be displayed 622 by a UI 124 element in an integrated development environment (IDE) 130, for example.

In some embodiments, after editing has inserted a block of code the enhanced editor keeps track of that block of code and allows the user to navigate to usage examples of that code.

In some embodiments, some of the ways to insert code include copy-paste, text insertion of gray text (e.g., generated suggestion, whole line autocompletion), and anything that adds a block of code to code already in the editor.

In some embodiments, after the code is added the editor adorns 606, 608 the block of code with metadata 316 that can give the user more information on how the code got there, where there are examples of usage of the code, or a human readable description of what the code does.

In some embodiments, in the case of a refactoring the adornment data 316 can contain more information, such as examples, and options for further actions 212 such as making an analyzer fixer out of this code suggestion.

In some embodiments, metadata 316 can be saved 608 and later be retrieved 314 at pull request time or other code review time. Reviewers can examine what actions occurred to get to this code. Metadata 316 can be used to explain during a review how the code works, or where there are more examples.

Some embodiments give users insights into the usage of an API after acceptance of a suggestion, e.g., a suggestion from an autocompletion mechanism 540 or a code generation mechanism 540. Some embodiments also or instead give insight at review 440 time, or later on. Some embodiments can track where a change came from (e.g., copy paste source 414, suggestion, or completion tool).

Making metadata 316 about an accepted code suggestion available 622 after acceptance of a tool suggestion is beneficial. When a developer is typing code and gets a suggestion from a tool, the developer may accept the suggestion even if the developer is not fully confident that the suggested code is correct. But reviewing such gray text code (i.e., code automatically suggested but not yet accepted for insertion) has been impractical or unsupported in many tools 130. Accordingly, in some embodiments after acceptance of a suggestion it is possible to get more information about why the change was suggested to the developer and let the developer and other code reviewers better evaluate whether the accepted code is actually solving a problem for the developer. Code written by the developer, or pasted in from a source 414 chosen by the developer, does not necessarily merit the same scrutiny, so it is also beneficial to distinguish in metadata 316 between accepted suggested code, and other code.

Some tools which generate code from a natural language description are enhanced with SDCH functionality 210 to preserve that description as retrievable 314 SDCH data 214.

Some web browsers are enhanced with SDCH functionality 210 to preserve queries 518 that were made to reach online forums or other internet sources 412 of code that is subsequently pasted 510 into a source code file. The queries 518, the pasted code's source 412 URL, and the pasted code are preserved as retrievable 314 SDCH data 214. In other embodiments, queries 518 are not preserved as retrievable 314 SDCH data 214, but the pasted code's source 412 URL and the pasted code are thus preserved.

In some embodiments, metadata 316 is collected and attached to code via an SDCH item 218 when pasting copied code, including the source 414 of the copy-paste, which might be an online open-source-code repo 330 for instance. Some embodiments flow existing metadata from the source 414 of the copy, e.g., to preserve intent, license information (e.g., for an open-source-code repo's code 132), revision dates, and other useful data from the origin.

In some embodiments, metadata 316 is collected and attached to code via an SDCH item 218 when accepting AI-based model text insertions.

In some embodiments, metadata 316 is collected and attached to code via an SDCH item 218 when inserting or filling in static snippets and templates.

In some embodiments, metadata 316 is collected and attached to code via an SDCH item 218 when using any code generation mechanism or operation, e.g., when generating a whole new project or set of code, or adding code from another project wholesale.

In some embodiments, metadata 316 is collected and attached to code via an SDCH item 218 when a developer creates code manually, by prompting the developer for commentary that explains the reasons for the code being the way it is. The developer commentary is preserved as SDCH metadata 316. Such commentary could otherwise be lost or unavailable for use in code reviews or use during maintenance of the source code.

In some embodiments, metadata 316 is collected and attached to code via an SDCH item 218 to preserve relevant research for the code block, e.g., an identification of the blogs, articles, forum discussions, and other reference sources 414 that were in use in the browser 130 when this code was being developed. These URLs are automatically captured as metadata 316, instead of burdening a developer by having the developer manually document them in comments 502 or having the developer remember to store the tabs as bookmarks (which would also be readily available only to the particular developer, unlike metadata 316).

In some embodiments, metadata 316 or other SDCH data 214 may be generated in response to an insertion operation 212 (e.g., paste 510, find-replace 516, refactor 528, autocompletion 538, generated 542 code acceptance, or manual typing). Such SDCH data 214 is referred to here as “insertion data” 214.

One benefit of tracking and utilizing insertion data 214 is that the insertion data 214 provides important contextual information to developers in various scenarios.

During code review scenarios, insertion data 214 improves developer understanding of code that came from automatic tools. In some embodiments, a reviewer can filter out such generated code in order to focus on manual changes to the code.

As another example, insertion data 214 supports code history rollback or “compare to working code” scenarios so that a developer can roll code versions back to when particular things were working. The insertion data 214 provides a clear label to compare versions or to roll back to a particular version.

During code maintenance scenarios, insertion data 214 allows a maintaining developer—who is not necessarily the developer behind the code insertion—to see important facts about the origin of that code. A developer can get the origin story of a piece of code even after the coders who wrote it have moved to other teams or other organizations. In some embodiments, the developer can see logs 444 that indicate issues in production which are associated with the inserted code. The maintaining developer may also gain useful familiarity with code by using predictive text, and by studying usage examples of the suggested code in other places.

In some embodiments, metadata 316 or other SDCH data 214 associated with a piece of code, e.g., a block 134, includes origin 414 data such as an assertion that this code came from a line completion tool, such as an AI or machine learning (ML) based autocompletion or suggestion tool. In some embodiments, origin 414 data asserts that the code came from a static code fixer, a static code analyzer, or a refactoring tool. The kind 552 of refactoring may also be specified, e.g., a rename, a method extract, or a coding style fix. The mechanism 534, 544, or 532 used may be specified in SDCH data 214. The insertion date may also be captured as SDCH data 214.

In some embodiments, certain other contextual history to know about the code is also considered part of the origin data 214, while in other embodiments these things are treated as a different kind 418 of SDCH data 214.

One example is an assertion that the code had certain characteristics when inserted, e.g., that the code had passed or failed specified unit tests, thus allowing a developer to roll back to when certain test results were obtained, and in some embodiments allowing a developer to do a diff to see what changed in the code since then.

Another example is a generated natural language comment 320 that explains what the inserted code was trying to do (e.g., generated by a code-to-text engine). This can help a developer understand and document the purpose of the code easily without having to remember to comment manually.

Another example is an assertion that the code insertion fixed a particular bug or issue, potentially with details of that bug or performance issue. This would be useful to a developer later maintaining that code. The log entries in a production service code that flowed from this piece of source code may also be specified or displayed, e.g., similar to “in v25 and v26 this message was logged, but not in v27”.

Many additional examples of displaying 622 an SDCH item or SDCH data 214 for an identified 604 software item lie within the scope of the teachings presented herein. This would include displaying 622, for example, informational notices 408 along the lines of the following assertions 408, which are shown below in quotes, with material in angle brackets < > indicating the location of specific data to be filled in by a system 202 in a particular circumstance.

“The highlighted block of code was pasted after being cut from the following location: <xyz>.”

“The highlighted block of code was accepted as an autogenerated suggestion, based on the following context given to the code generator as input: <xyz>.”

“The highlighted block of code was refactored from this original version: <link>.” In a variation, an assertion 408 provides context to developers consuming the information 214 as maintainers, reviewers or even as people who command an enhanced system in a roll back scenario, by calling out an example of the actual refactoring used, e.g., “The highlighted block of code was refactored by a method extraction from this original version:<link>”

“During a code review on <date>, reviewer <A> added the following remark about the highlighted code: <xyz>.” An assertion may note not merely what a reviewer remarked but also note that the developer then changed their code in response to the remark, e.g., “This block of code was modified from <link> in response to a code review comment on <date> by reviewer <reviewer name>”. Showing an origin story of the code provides additional context to reviewers, maintainers, and other people, and aids understanding of the added code.

“Versions <N1> and <N2> of the highlighted code failed these unit tests: <xyz>.” A variation also helps a developer understand when code is changed in response to passing or failing unit tests, e.g., “The highlighted code began <failing/passing> the <xyz> tests between versions <AAA> and <BBB>.”

“Developer <A> included the following as research while drafting the highlighted code: <URL1>, . . . , <URLk>.”

“Production version <N> raised an exception at the highlighted point in the code.”

“Static analyzer <X> generated these warnings for the highlighted code: <link>.” A variation is “This code was changed in response to static analyzer <X>'s warning or suggestion.” Knowing why code was changed not only helps the code reviewer or maintainer but might also provide training data for a machine learning model designed to predict suggested changes for later instances of the same problem.

An assertion may also note that highlighted code is tagged with particular tags 326. Some of the many possible tags 326 include: OpenSourceLicense, BugFixed, SecurityUpgrade, CodeReviewerRemarks, PerformanceNote, CodeOriginlnfo, CodeUsageExample, PastedCode, AutogeneratedCode, RefactoredCode, DevResearchNote, PRComment, StaticAnalysisRecoFixed, and TestFailFixed.

Although tags are one way to implement categories 324, there are other ways as well, e.g., each file/folder/list/etc. of SDCH items 218 could correspond to a different category 324, or each context history data structure 218 could have a category field or a categories bitmap.

Technical Character

The technical character of embodiments described herein will be apparent to one of ordinary skill in the art, and will also be apparent in several ways to a wide range of attentive readers. Some embodiments address technical activities such as receiving 602 edit operations in a software development tool 130, generating 606 SDCH data structures 218, retrieving 314 SDCH data 214, and software development 204, which are each an activity deeply rooted in computing technology. Some of the technical mechanisms discussed include, e.g., SDCH software 302, user interfaces 124, source code refactoring mechanisms 530, source code static analysis mechanisms 530, source code autocompletion mechanisms 540, source code generation (a.k.a. synthesis) mechanisms 544, and software development tools 130. Some of the technical effects discussed include, e.g., improving software developer 104 productivity, improving software quality for a broad range of software 132, generating, storing and retrieving SDCH data 214 using SDCH data structures 218 in enhanced systems 202, and various technical benefits called out at different points within the present disclosure. Thus, purely mental processes and activities limited to pen-and-paper are clearly excluded. Other advantages based on the technical characteristics of the teachings will also be apparent to one of skill from the description provided.

Different embodiments may provide different technical benefits or other advantages in different circumstances, but one of skill informed by the teachings herein will acknowledge that particular technical advantages will likely follow from particular innovation features or feature combinations.

Some embodiments described herein may be viewed by some people in a broader context. For instance, concepts such as efficiency, reliability, user satisfaction, or waste may be deemed relevant to a particular embodiment. However, it does not follow from the availability of a broad context that exclusive rights are being sought herein for abstract ideas; they are not. Rather, the present disclosure is focused on providing appropriately specific embodiments whose technical effects fully or partially solve particular technical problems, such as such as how to increase consistency and event 452 coverage when tracking source code 132 changes 212, how to determine which otherwise ephemeral software development contextual information 214 to record 608, and how to meet these and other technical challenges discussed herein without further burdening 306 software developers 104. Other configured storage media, systems, and processes involving efficiency, reliability, user satisfaction, or waste are outside the present scope. Accordingly, vagueness, mere abstractness, lack of technical character, and accompanying proof problems are also avoided under a proper understanding of the present disclosure.

Additional Combinations and Variations

Any of these combinations of software code, data structures, logic, components, communications, and/or their functional equivalents may also be combined with any of the systems and their variations described above. A process may include any steps described herein in any subset or combination or sequence which is operable. Each variant may occur alone, or in combination with any one or more of the other variants. Each variant may occur with any of the processes and each process may be combined with any one or more of the other processes. Each process or combination of processes, including variants, may be combined with any of the configured storage medium combinations and variants described above.

More generally, one of skill will recognize that not every part of this disclosure, or any particular details therein, are necessarily required to satisfy legal criteria such as enablement, written description, or best mode. Also, embodiments are not limited to the particular scenarios, motivating examples, operating environments, peripherals, software process flows, identifiers, data structures, data selections, naming conventions, notations, control flows, or other embodiment implementation choices described herein. Any apparent conflict with any other patent disclosure, even from the owner of the present innovations, has no role in interpreting the claims presented in this patent disclosure.

Acronyms, Abbreviations, Names, and Symbols

Some acronyms, abbreviations, names, and symbols are defined below. Others are defined elsewhere herein, or do not require definition here in order to be understood by one of skill.
ALU: arithmetic and logic unit
API: application program interface
BIOS: basic input/output system
CD: compact disc
CPU: central processing unit
DVD: digital versatile disk or digital video disc
FPGA: field-programmable gate array
FPU: floating point processing unit
GDPR: General Data Protection Regulation
GPU: graphical processing unit
GUI: graphical user interface
HTTPS: hypertext transfer protocol, secure
IaaS or IAAS: infrastructure-as-a-service
ID: identification or identity
LAN: local area network
MAC address: media access control address
OS: operating system
PaaS or PAAS: platform-as-a-service
RAM: random access memory
ROM: read only memory
TPU: tensor processing unit
UEFI: Unified Extensible Firmware Interface
UI: user interface
WAN: wide area network

Some Additional Terminology

Reference is made herein to exemplary embodiments such as those illustrated in the drawings, and specific language is used herein to describe the same. But alterations and further modifications of the features illustrated herein, and additional technical applications of the abstract principles illustrated by particular embodiments herein, which would occur to one skilled in the relevant art(s) and having possession of this disclosure, should be considered within the scope of the claims.

The meaning of terms is clarified in this disclosure, so the claims should be read with careful attention to these clarifications. Specific examples are given, but those of skill in the relevant art(s) will understand that other examples may also fall within the meaning of the terms used, and within the scope of one or more claims. Terms do not necessarily have the same meaning here that they have in general usage (particularly in non-technical usage), or in the usage of a particular industry, or in a particular dictionary or set of dictionaries. Reference numerals may be used with various phrasings, to help show the breadth of a term. Omission of a reference numeral from a given piece of text does not necessarily mean that the content of a Figure is not being discussed by the text. The inventors assert and exercise the right to specific and chosen lexicography. Quoted terms are being defined explicitly, but a term may also be defined implicitly without using quotation marks. Terms may be defined, either explicitly or implicitly, here in the Detailed Description and/or elsewhere in the application file.

A “computer system” (a.k.a. “computing system”) may include, for example, one or more servers, motherboards, processing nodes, laptops, tablets, personal computers (portable or not), personal digital assistants, smartphones, smartwatches, smart bands, cell or mobile phones, other mobile devices having at least a processor and a memory, video game systems, augmented reality systems, holographic projection systems, televisions, wearable computing systems, and/or other device(s) providing one or more processors controlled at least in part by instructions. The instructions may be in the form of firmware or other software in memory and/or specialized circuitry.

A “multithreaded” computer system is a computer system which supports multiple execution threads. The term “thread” should be understood to include code capable of or subject to scheduling, and possibly to synchronization. A thread may also be known outside this disclosure by another name, such as “task,” “process,” or “coroutine,” for example. However, a distinction is made herein between threads and processes, in that a thread defines an execution path inside a process. Also, threads of a process share a given address space, whereas different processes have different respective address spaces. The threads of a process may run in parallel, in sequence, or in a combination of parallel execution and sequential execution (e.g., time-sliced).

A “processor” is a thread-processing unit, such as a core in a simultaneous multithreading implementation. A processor includes hardware. A given chip may hold one or more processors. Processors may be general purpose, or they may be tailored for specific uses such as vector processing, graphics processing, signal processing, floating-point arithmetic processing, encryption, I/O processing, machine learning, and so on.

“Kernels” include operating systems, hypervisors, virtual machines, BIOS or UEFI code, and similar hardware interface software.

“Code” means processor instructions, data (which includes constants, variables, and data structures), or both instructions and data. “Code” and “software” are used interchangeably herein. Source code, executable code, interpreted code, and firmware are some examples of code.

“Program” is used broadly herein, to include applications, kernels, drivers, interrupt handlers, firmware, state machines, libraries, and other code written by programmers (who are also referred to as developers) and/or automatically generated.

A “routine” is a callable piece of code which normally returns control to an instruction just after the point in a program execution at which the routine was called. Depending on the terminology used, a distinction is sometimes made elsewhere between a “function” and a “procedure”: a function normally returns a value, while a procedure does not. As used herein, “routine” includes both functions and procedures. A routine may have code that returns a value (e.g., sin(x)) or it may simply return without also providing a value (e.g., void functions).

“Service” means a consumable program offering, in a cloud computing environment or other network or computing system environment, which provides resources to multiple programs or provides resource access to multiple programs, or does both. A service implementation may itself include multiple applications or other programs.

“Cloud” means pooled resources for computing, storage, and networking which are elastically available for measured on-demand service. A cloud may be private, public, community, or a hybrid, and cloud services may be offered in the form of infrastructure as a service (IaaS), platform as a service (PaaS), software as a service (SaaS), or another service. Unless stated otherwise, any discussion of reading from a file or writing to a file includes reading/writing a local file or reading/writing over a network, which may be a cloud network or other network, or doing both (local and networked read/write). A cloud may also be referred to as a “cloud environment” or a “cloud computing environment”.

“IoT” or “Internet of Things” means any networked collection of addressable embedded computing or data generation or actuator nodes. An individual node is referred to as an internet of things device or IoT device. Such nodes may be examples of computer systems as defined herein, and may include or be referred to as a “smart” device, “endpoint”, “chip”, “label”, or “tag”, for example, and IoT may be referred to as a “cyber-physical system”. IoT nodes and systems typically have at least two of the following characteristics: (a) no local human-readable display; (b) no local keyboard; (c) a primary source of input is sensors that track sources of non-linguistic data to be uploaded from the IoT device; (d) no local rotational disk storage— RAM chips or ROM chips provide the only local memory; (e) no CD or DVD drive; (f) embedment in a household appliance or household fixture; (g) embedment in an implanted or wearable medical device; (h) embedment in a vehicle; (i) embedment in a process automation control system; or (j) a design focused on one of the following: environmental monitoring, civic infrastructure monitoring, agriculture, industrial equipment monitoring, energy usage monitoring, human or animal health or fitness monitoring, physical security, physical transportation system monitoring, object tracking, inventory control, supply chain control, fleet management, or manufacturing. IoT communications may use protocols such as TCP/IP, Constrained Application Protocol (CoAP), Message Queuing Telemetry Transport (MQTT), Advanced Message Queuing Protocol (AMQP), HTTP, HTTPS, Transport Layer Security (TLS), UDP, or Simple Object Access Protocol (SOAP), for example, for wired or wireless (cellular or otherwise) communication. IoT storage or actuators or data output or control may be a target of unauthorized access, either via a cloud, via another network, or via direct local access attempts.

“Access” to a computational resource includes use of a permission or other capability to read, modify, write, execute, move, delete, create, or otherwise utilize the resource. Attempted access may be explicitly distinguished from actual access, but “access” without the “attempted” qualifier includes both attempted access and access actually performed or provided.

As used herein, “include” allows additional elements (i.e., includes means comprises) unless otherwise stated.

“Optimize” means to improve, not necessarily to perfect. For example, it may be possible to make further improvements in a program or an algorithm which has been optimized.

“Process” is sometimes used herein as a term of the computing science arts, and in that technical sense encompasses computational resource users, which may also include or be referred to as coroutines, threads, tasks, interrupt handlers, application processes, kernel processes, procedures, or object methods, for example. As a practical matter, a “process” is the computational entity identified by system utilities such as Windows® Task Manager, Linux® ps, or similar utilities in other operating system environments (marks of Microsoft Corporation, Linus Torvalds, respectively). “Process” is also used herein as a patent law term of art, e.g., in describing a process claim as opposed to a system claim or an article of manufacture (configured storage medium) claim. Similarly, “method” is used herein at times as a technical term in the computing science arts (a kind of “routine”) and also as a patent law term of art (a “process”). “Process” and “method” in the patent law sense are used interchangeably herein. Those of skill will understand which meaning is intended in a particular instance, and will also understand that a given claimed process or method (in the patent law sense) may sometimes be implemented using one or more processes or methods (in the computing science sense).

“Automatically” means by use of automation (e.g., general purpose computing hardware configured by software for specific operations and technical effects discussed herein), as opposed to without automation. In particular, steps performed “automatically” are not performed by hand on paper or in a person's mind, although they may be initiated by a human person or guided interactively by a human person. Automatic steps are performed with a machine in order to obtain one or more technical effects that would not be realized without the technical interactions thus provided. Steps performed automatically are presumed to include at least one operation performed proactively.

One of skill understands that technical effects are the presumptive purpose of a technical embodiment. The mere fact that calculation is involved in an embodiment, for example, and that some calculations can also be performed without technical components (e.g., by paper and pencil, or even as mental steps) does not remove the presence of the technical effects or alter the concrete and technical nature of the embodiment, particularly in real-world embodiment implementations. Software development context history operations such as receiving 602 edit operations, generating 606 SDCH data structures 218, storing 608 and retrieving SDCH data using data structures 218, performing 630 version rollbacks 632 based on SDCH data 214 search or filter parameters 524, and many other operations discussed herein, are understood to be inherently digital. A human mind cannot interface directly with a CPU or other processor, or with RAM or other digital storage, to read and write the necessary data to perform the software development context history operations steps 600 taught herein even in a hypothetical prototype situation, much less in an embodiment's real world large computing environment. This would all be well understood by persons of skill in the art in view of the present disclosure.

“Computationally” likewise means a computing device (processor plus memory, at least) is being used, and excludes obtaining a result by mere human thought or mere human action alone. For example, doing arithmetic with a paper and pencil is not doing arithmetic computationally as understood herein. Computational results are faster, broader, deeper, more accurate, more consistent, more comprehensive, and/or otherwise provide technical effects that are beyond the scope of human performance alone. “Computational steps” are steps performed computationally. Neither “automatically” nor “computationally” necessarily means “immediately”. “Computationally” and “automatically” are used interchangeably herein.

“Proactively” means without a direct request from a user. Indeed, a user may not even realize that a proactive step by an embodiment was possible until a result of the step has been presented to the user. Except as otherwise stated, any computational and/or automatic step described herein may also be done proactively.

“Based on” means based on at least, not based exclusively on. Thus, a calculation based on X depends on at least X, and may also depend on Y.

Throughout this document, use of the optional plural “(s)”, “(es)”, or “(ies)” means that one or more of the indicated features is present. For example, “processor(s)” means “one or more processors” or equivalently “at least one processor”.

For the purposes of United States law and practice, use of the word “step” herein, in the claims or elsewhere, is not intended to invoke means-plus-function, step-plus-function, or 35 United State Code Section 112 Sixth Paragraph/Section 112(f) claim interpretation. Any presumption to that effect is hereby explicitly rebutted.

For the purposes of United States law and practice, the claims are not intended to invoke means-plus-function interpretation unless they use the phrase “means for”. Claim language intended to be interpreted as means-plus-function language, if any, will expressly recite that intention by using the phrase “means for”. When means-plus-function interpretation applies, whether by use of “means for” and/or by a court's legal construction of claim language, the means recited in the specification for a given noun or a given verb should be understood to be linked to the claim language and linked together herein by virtue of any of the following: appearance within the same block in a block diagram of the figures, denotation by the same or a similar name, denotation by the same reference numeral, a functional relationship depicted in any of the figures, a functional relationship noted in the present disclosure's text. For example, if a claim limitation recited a “zac gadget” and that claim limitation became subject to means-plus-function interpretation, then at a minimum all structures identified anywhere in the specification in any figure block, paragraph, or example mentioning “zac gadget”, or tied together by any reference numeral assigned to a zac gadget, or disclosed as having a functional relationship with the structure or operation of a zac gadget, would be deemed part of the structures identified in the application for zac gadget and would help define the set of equivalents for zac gadget structures.

One of skill will recognize that this innovation disclosure discusses various data values and data structures, and recognize that such items reside in a memory (RAM, disk, etc.), thereby configuring the memory. One of skill will also recognize that this innovation disclosure discusses various algorithmic steps which are to be embodied in executable code in a given implementation, and that such code also resides in memory, and that it effectively configures any general-purpose processor which executes it, thereby transforming it from a general-purpose processor to a special-purpose processor which is functionally special-purpose hardware.

Accordingly, one of skill would not make the mistake of treating as non-overlapping items (a) a memory recited in a claim, and (b) a data structure or data value or code recited in the claim. Data structures and data values and code are understood to reside in memory, even when a claim does not explicitly recite that residency for each and every data structure or data value or piece of code mentioned. Accordingly, explicit recitals of such residency are not required. However, they are also not prohibited, and one or two select recitals may be present for emphasis, without thereby excluding all the other data values and data structures and code from residency. Likewise, code functionality recited in a claim is understood to configure a processor, regardless of whether that configuring quality is explicitly recited in the claim.

Throughout this document, unless expressly stated otherwise any reference to a step in a process presumes that the step may be performed directly by a party of interest and/or performed indirectly by the party through intervening mechanisms and/or intervening entities, and still lie within the scope of the step. That is, direct performance of the step by the party of interest is not required unless direct performance is an expressly stated requirement. For example, a computational step on behalf of a party of interest, such as analyzing, ascertaining, asserting, associating, comparing, completing, displaying, editing, filtering, generating, getting, identifying, listing, matching, pasting, performing, receiving, recognizing, refactoring, replacing, responding, rolling back, searching, setting, showing, storing, testing, triggering, (and analyzes, analyzed, ascertains, ascertained, etc.) with regard to a destination or other subject may involve intervening action, such as the foregoing or such as forwarding, copying, uploading, downloading, encoding, decoding, compressing, decompressing, encrypting, decrypting, authenticating, invoking, and so on by some other party or mechanism, including any action recited in this document, yet still be understood as being performed directly by or on behalf of the party of interest.

Whenever reference is made to data or instructions, it is understood that these items configure a computer-readable memory and/or computer-readable storage medium, thereby transforming it to a particular article, as opposed to simply existing on paper, in a person's mind, or as a mere signal being propagated on a wire, for example. For the purposes of patent protection in the United States, a memory or other computer-readable storage medium is not a propagating signal or a carrier wave or mere energy outside the scope of patentable subject matter under United States Patent and Trademark Office (USPTO) interpretation of the In re Nuijten case. No claim covers a signal per se or mere energy in the United States, and any claim interpretation that asserts otherwise in view of the present disclosure is unreasonable on its face. Unless expressly stated otherwise in a claim granted outside the United States, a claim does not cover a signal per se or mere energy.

Moreover, notwithstanding anything apparently to the contrary elsewhere herein, a clear distinction is to be understood between (a) computer readable storage media and computer readable memory, on the one hand, and (b) transmission media, also referred to as signal media, on the other hand. A transmission medium is a propagating signal or a carrier wave computer readable medium. By contrast, computer readable storage media and computer readable memory are not propagating signal or carrier wave computer readable media. Unless expressly stated otherwise in the claim, “computer readable medium” means a computer readable storage medium, not a propagating signal per se and not mere energy.

An “embodiment” herein is an example. The term “embodiment” is not interchangeable with “the invention”. Embodiments may freely share or borrow aspects to create other embodiments (provided the result is operable), even if a resulting combination of aspects is not explicitly described per se herein. Requiring each and every permitted combination to be explicitly and individually described is unnecessary for one of skill in the art, and would be contrary to policies which recognize that patent specifications are written for readers who are skilled in the art. Formal combinatorial calculations and informal common intuition regarding the number of possible combinations arising from even a small number of combinable features will also indicate that a large number of aspect combinations exist for the aspects described herein. Accordingly, requiring an explicit recitation of each and every combination would be contrary to policies calling for patent specifications to be concise and for readers to be knowledgeable in the technical fields concerned.

### LIST OF REFERENCE NUMERALS

The following list is provided for convenience and in support of the drawing figures and as part of the text of the specification, which describe innovations by reference to multiple items. Items not listed here may nonetheless be part of a given embodiment. For better legibility of the text, a given reference number is recited near some, but not all, recitations of the referenced item in the text. The same reference number may be used with reference to different examples or different instances of a given item. The list of reference numerals is:
100 operating environment, also referred to as computing environment; includes one or more systems 102
101 machine in a system 102, e.g., any device having at least a processor 110 and a memory 112 and also having a distinct identifier such as an IP address or a MAC (media access control) address; may be a physical machine or be a virtual machine implemented on physical hardware
102 computer system, also referred to as a “computational system” or “computing system”, and when in a network may be referred to as a “node”
104 users, e.g., user of an enhanced system 202, such as a developer or programmer; refers to a human or a human's online identity unless otherwise stated
106 peripheral device
108 network generally, including, e.g., LANs, WANs, software-defined networks, clouds, and other wired or wireless networks
110 processor; includes hardware
112 computer-readable storage medium, e.g., RAM, hard disks
114 removable configured computer-readable storage medium
116 instructions executable with processor; may be on removable storage media or in other memory (volatile or nonvolatile or both)
118 digital data in a system 102
120 kernel(s), e.g., operating system(s), BIOS, UEFI, device drivers
122 applications, e.g., version control systems, cybersecurity tools, software development tools, office productivity tools, social media tools, diagnostics, browsers, games, email and other communication tools, commands, and so on
124 user interface; hardware and software
126 display screens, also referred to as “displays”
128 computing hardware not otherwise associated with a reference number 106, 108, 110, 112, 114
130 tool, especially software development tool, e.g., editor, IDE, profiler, static analyzer, version control tool, repository software, or other tool used to create, document, modify, build, deploy, test, analyze, profile, monitor, or otherwise develop software
132 software source code; digital
134 block of source code, not necessarily contiguous, target or result of an edit command; digital
136 file, especially file containing source code; digital
138 cloud, cloud computing environment
202 system 102 enhanced with SDCH functionality 210
204 software development, e.g., any activity which uses a software development tool, or creates, documents, modifies, builds, deploys, tests, profiles, monitors, or analyzes software, as represented in a system 102 (purely mental or paper-and-pencil activity is excluded)
206 software development context, as represented in a system 102, e.g., data representing any item or event in FIG. 4 or FIG. 5
208 software development context history (SDCH), e.g., occurrence of software development context changes along with timestamps or another ordering
210 software development context history (SDCH) functionality; e.g., software or specialized hardware which performs or is configured to perform at least one of these sets of steps: {604, 606, 312}, {312, 608}, {630, 636}, {314, 622}, {610, 314}, {612, 314}, or any software or hardware which performs or is configured to perform a method 600 or a software development context history creation, tracking, modification, or utilization activity first disclosed herein
212 source code editing operation, as represented in a system 102; does not necessarily change the source code, e.g., opening a file of source code, scrolling within the file, and closing the file are editing operations, in addition to copy, paste, find, replace, and other operations that do typically change source code
214 SDCH data; digital
218 SDCH data structure which functionally associates at least on piece of SDCH data with at least one piece of source code; digital
220 source code editing, as represented in a system 102
302 SDCH software, e.g., software which upon execution performs at least on set of steps defined above to provide SDCH functionality
304 ease a developer burden by relieving a developer of a software development work presumption or requirement, or by avoiding imposing the software development work presumption or requirement on the developer at all
306 developer burden, e.g., a software development work presumption or requirement, especially one related to source code or its derivative code such as creating, documenting, modifying, building, deploying, testing, profiling, monitoring, or analyzing software
308 improve interaction between a developer and a tool, e.g., by increasing the ease, speed, reliability, accuracy, scope, or usability of access to desired information using the tool
310 interaction between a developer and a tool, as represented in a system 102 which may include the tool, or be the tool, or simply monitor the tool
312 computationally associate SDCH data with source code, e.g., by creating, updating, or otherwise generating an SDCH data structure 218 that correlates the SDCH data and the source code; may also be referred to as associating the SDCH item 218 with the source code, or as associating the source code with the SDCH item or with the SDCH data
314 computationally retrieve SDCH data 214 that is associated with particular source code, by using an SDCH item 218; may also be referred to as retrieving the SDCH item 218; more generally, retrieval 314 may computationally retrieve source code based on SDCH data or computationally retrieve SDCH data based on a source code identification, or do both; the “retrieval” in “SDCH data retrieval data structure” is exemplary, not limiting, in that an actual retrieval of SDCH data 214 is not required for a data structure to serve as an SDCH data retrieval data structure 218 a.k.a. SDCH item 218
316 SDCH metadata; digital
318 metadata-based storage format of SDCH data as opposed to comment storage format of SDCH data, in each case as represented in a system 102
320 SDCH system-generated comment; digital
322 comment-based storage format of SDCH data as opposed to metadata storage format of SDCH data, in each case as represented in a system 102
324 SDCH data category as represented in a system 102; may be, e.g., an SDCH data kind 418, ora category in a categorization based on which operation is involved such as paste, refactor, and so on, or a categorization that distinguishes between editing and other context such as analysis or testing, or may be a user-defined category
326 SDCH data category designation, e.g., a set of one or more categories associated with particular SDCH data; digital
328 version of source code, or of a program, as represented in a system 102
330 version control system, also referred to as version control repository
332 interface generally; computational
402 time, e.g., a particular point in time or a period of time, or a digital representation thereof
404 bug or other defect in software
406 fix or remediation of defect 404
408 assertion, e.g., statement or graph or other representation of fact or conclusion presented by a system 102 via an interface
410 security upgrade, e.g., patch or update that reduces or removes a security vulnerability or improves data confidentiality, data integrity, data availability, or data privacy in a system 102
412 internet origin of source code, as represented, e.g., by a URL or other network address
414 origin of source code, as represented in a system 102; note that “source” is used herein as a modifier to specify a kind of code—source code—and is also used by itself as a synonym for “origin”, so one could refer clearly and meaningfully to a “source code source”, i.e., a source 414 of source code 132
416 repository origin of source code, as represented in a system 102
418 kind of SDCH data
420 usage of source code, as represented in a system 102
422 natural language, e.g., Arabic, Chinese, English, French, German, Hebrew, Hindi, Japanese, Korean, Spanish, etc.; as opposed to a programming language
424 written description of source code, as represented in a system 102
426 testing of code (including source 132 or executable code, kernel 120, application 122, tool 130, local or networked code); refers to computational activity of testing or to tests themselves as represented in a system 102, or testing tools 130
428 result of testing 426, as represented in a system 102
430 static analysis of source code, as represented in a system 102; refers to computational activity of performing static analysis or to tools 130 designed for performing static analysis
432 result of static analysis 430, as represented in a system 102
434 performance, e.g., execution of code on hardware of a system 102, alone or along with other code
436 result of performance 434, as represented in a system 102
438 condition or event that triggers a display 622 of SDCH data, as represented in a system 102
440 code review activity
442 code review remark, e.g., observation, note, to-do, warning, report, or other result of a code review 440, as represented in a system 102
444 log of events or statuses, as represented in a system 102
446 digital entry in a log 444
448 identification of particular source code within a file or within an editor or other tool; may be implemented, e.g., using an index or pointer to a start location in source code plus a length, or two indexes or pointers as start and end location indications, or start and end markers embedded as non-displayable data in a source code, or by other data structure mechanisms, and may include a plurality of such data structure mechanisms in a set when the source code identified includes non-contiguous pieces; an identification 448 may identify a piece of source code as small as a single identifier or as large as a set of files, or anything in between
450 set including least one SDCH item 218, as represented in a system 102
452 software development event, as represented in a system 102
502 comment generally in source code 132; comment syntax is defined by programming language used
504 line of source code 132, e.g., a delimited by \n or \r\n characters
506 character in of source code 132, e.g., per ASCII, UTF-8, UTF-16 or other encoding; digital (ASCII is American Standard Code for Information Interchange, UTF is Unicode Transformation Format)
508 copy operation in a tool 130
510 paste operation in a tool 130
512 similarity of source codes, or measure of similarity, or computational activity of measuring similarity; may employ, e.g., finding similar subgraphs, using reference vectors, counting number of edit operations to transform one code to the other, using a plagiarism detection tool, comparing abstract syntax trees, comparing character strings, or a combination thereof
514 find operation in a tool 130
516 replace operation in a tool 130
518 query fed to search engine or another search tool; digital
520 search; computational activity
522 filter; computational activity; search and filter may be distinguished in that search is interactive—human supplies search parameter when requesting a search
524 parameter for search or filter, e.g., value to match, value to exclude, or combination of values to match or exclude from results of search or filter
526 display setting; digital value which guides whether or how display 622 occurs
528 refactor operation in a tool 130
530 computational mechanism which performs refactor 528
532 edit command, e.g., copy, paste, find, find-and-replace, refactor, complete via autocompletion, sort, reformat, and so on; computational
534 computational mechanism which performs static analysis 430
536 software library or API of a software library; digital
538 automatic completion of a portion of source code; computational
540 computational mechanism which performs autocompletion 538
542 automatic generation of a portion of source code; also referred to herein as code synthesis; computational
544 computational mechanism which performs code generation 542
546 digital input to a code generation mechanism 544
548 software license or license status, as represented in a system 102, or computational activity of checking license status or obtaining a license
550 combination of two or more libraries 536 used by a particular piece of code
552 kind of refactor, as represented in a system 102
554 kind of static analysis, as represented in a system 102
600 flowchart; 600 also refers to SDCH methods that are illustrated by or consistent with the FIG. 6 flowchart
602 computationally receive an edit operation, e.g., via a user interface
604 computationally identify a piece of source code, e.g., based on cursor location, content of clipboard, highlighting or other selection, string comparison, particular edit command, or other digital values
606 computationally generate an SDCH item 218, e.g., by allocating memory for a data structure and entering at least two kinds of data into the allocated memory: a code identification 448 and SDCH data 214; generating 606 may also refer to updating previously allocated memory by updating code identification data 448 or SDCH data 214 or both
608 computationally store an SDCH item 218, e.g., in a metadata format 318 or a system-generated comment format 322 or both
610 computationally get a code identification 448, e.g., by step 604 or from an SDCH item 218
612 computationally respond to a trigger 438, e.g., by proactively getting 610 a code identification
614 computationally ascertain whether SDCH data is enabled for display, e.g., based on the kind of SDCH data, or a display setting
616 display enablement status of SDCH data, as represented in a system 202
618 computationally match 618 a search 520 parameter 524 to SDCH data or to a category designation 326 of SDCH data
620 computationally compare a code review 440 filter 522 to SDCH data or to a category designation 326 of SDCH data, or computationally compare an SDCH data display setting 526 to SDCH data or to a category designation 326 of SDCH data
622 computationally display SDCH data or other content associated with an SDCH item, e.g., by configuring a display or utilizing a user interface output capability, or both
624 computationally show data, e.g., via a display 126 or printer or in an email or text message
626 computationally identify data, e.g., by showing a URL or other address where the data can be viewed
628 computationally list a software libraries combination 550, e.g., by showing names or other identifiers of the libraries that are part of the combination
630 computationally perform a version rollback 632 based on SDCH data 214
632 version rollback, e.g., a result of computationally locating or computationally generating a prior version of a source code; may be focused on the particular piece of source code or on an entire file, that is, some embodiments allow rolling back 630 only a selected portion of a file, at least so far as what is displayed to the user is concerned
634 computationally get a parameter 524, e.g., as a default, from a display setting 526, or interactively via a user interface 124
636 computationally match a parameter 524 to SDCH data or to a category designation 326 of SDCH data
638 computationally recognize a testing result 428 that is associated with source code by an SDCH item 218
640 any step or item discussed in the present disclosure that has not been assigned some other reference numeral; 640 may thus be shown expressly as a reference numeral for various steps or items or both, and may be added as a reference numeral for various steps or items or both without thereby adding new matter to the present disclosure

### CONCLUSION

In short, the teachings herein provide a variety of software development context history (SDCH) functionalities 210 which operate in enhanced systems 202. Historic context data 214 is automatically associated 312 with particular pieces of source code 132 by retrieval data structures 218. Ephemeral information is preserved, such as how a piece of code originated 414 operationally and was changed over time, which research sources 414 informed the code's origination and changes, and why particular changes 220 in the code were made. Code 132 may be rolled back 630 to an earlier version 328 based on parameters 524 such as whether code had been refactored 528, or results 428, 432 of testing 426 or static analysis 430. Rollback 632 capability goes beyond editor undo actions, and a developer need not specify a timestamp 402 or a version 328 number. Developer documentation burdens are reduced 304, developer understanding is increased, and code quality is enhanced, by providing ready access 622 to the code's software development context history data 214. Some actions made possible include highlighting 622 code that was generated 542 automatically by autocompletion 538 or otherwise, highlighting 622 refactored 528 code, and highlighting 622 pasted 510 code, among other actions.

Embodiments are understood to also themselves include or benefit from tested and appropriate security controls and privacy controls such as the General Data Protection Regulation (GDPR). Use of the tools and techniques taught herein is compatible with use of such controls.

Although Microsoft technology is used in some motivating examples, the teachings herein are not limited to use in technology supplied or administered by Microsoft. Under a suitable license, for example, the present teachings could be embodied in software or services provided by other cloud service providers.

Although particular embodiments are expressly illustrated and described herein as processes, as configured storage media, or as systems, it will be appreciated that discussion of one type of embodiment also generally extends to other embodiment types. For instance, the descriptions of processes in connection with the Figures also help describe configured storage media, and help describe the technical effects and operation of systems and manufactures like those discussed in connection with other Figures. It does not follow that any limitations from one embodiment are necessarily read into another. In particular, processes are not necessarily limited to the data structures and arrangements presented while discussing systems or manufactures such as configured memories.

Those of skill will understand that implementation details may pertain to specific code, such as specific thresholds, comparisons, specific kinds of platforms or programming languages or architectures, specific scripts or other tasks, and specific computing environments, and thus need not appear in every embodiment. Those of skill will also understand that program identifiers and some other terminology used in discussing details are implementation-specific and thus need not pertain to every embodiment. Nonetheless, although they are not necessarily required to be present here, such details may help some readers by providing context and/or may illustrate a few of the many possible implementations of the technology discussed herein.

With due attention to the items provided herein, including technical processes, technical effects, technical mechanisms, and technical details which are illustrative but not comprehensive of all claimed or claimable embodiments, one of skill will understand that the present disclosure and the embodiments described herein are not directed to subject matter outside the technical arts, or to any idea of itself such as a principal or original cause or motive, or to a mere result per se, or to a mental process or mental steps, or to a business method or prevalent economic practice, or to a mere method of organizing human activities, or to a law of nature per se, or to a naturally occurring thing or process, or to a living thing or part of a living thing, or to a mathematical formula per se, or to isolated software per se, or to a merely conventional computer, or to anything wholly imperceptible or any abstract idea per se, or to insignificant post-solution activities, or to any method implemented entirely on an unspecified apparatus, or to any method that fails to produce results that are useful and concrete, or to any preemption of all fields of usage, or to any other subject matter which is ineligible for patent protection under the laws of the jurisdiction in which such protection is sought or is being licensed or enforced.

Reference herein to an embodiment having some feature X and reference elsewhere herein to an embodiment having some feature Y does not exclude from this disclosure embodiments which have both feature X and feature Y, unless such exclusion is expressly stated herein. All possible negative claim limitations are within the scope of this disclosure, in the sense that any feature which is stated to be part of an embodiment may also be expressly removed from inclusion in another embodiment, even if that specific exclusion is not given in any example herein. The term “embodiment” is merely used herein as a more convenient form of “process, system, article of manufacture, configured computer readable storage medium, and/or other example of the teachings herein as applied in a manner consistent with applicable law.” Accordingly, a given “embodiment” may include any combination of features disclosed herein, provided the embodiment is consistent with at least one claim.

Not every item shown in the Figures need be present in every embodiment. Conversely, an embodiment may contain item(s) not shown expressly in the Figures. Although some possibilities are illustrated here in text and drawings by specific examples, embodiments may depart from these examples. For instance, specific technical effects or technical features of an example may be omitted, renamed, grouped differently, repeated, instantiated in hardware and/or software differently, or be a mix of effects or features appearing in two or more of the examples. Functionality shown at one location may also be provided at a different location in some embodiments; one of skill recognizes that functionality modules can be defined in various ways in a given implementation without necessarily omitting desired technical effects from the collection of interacting modules viewed as a whole. Distinct steps may be shown together in a single box in the Figures, due to space limitations or for convenience, but nonetheless be separately performable, e.g., one may be performed without the other in a given performance of a method.

Reference has been made to the figures throughout by reference numerals. Any apparent inconsistencies in the phrasing associated with a given reference numeral, in the figures or in the text, should be understood as simply broadening the scope of what is referenced by that numeral. Different instances of a given reference numeral may refer to different embodiments, even though the same reference numeral is used. Similarly, a given reference numeral may be used to refer to a verb, a noun, and/or to corresponding instances of each, e.g., a processor 110 may process 110 instructions by executing them.

As used herein, terms such as “a”, “an”, and “the” are inclusive of one or more of the indicated item or step. In particular, in the claims a reference to an item generally means at least one such item is present and a reference to a step means at least one instance of the step is performed. Similarly, “is” and other singular verb forms should be understood to encompass the possibility of “are” and other plural forms, when context permits, to avoid grammatical errors or misunderstandings.

Headings are for convenience only; information on a given topic may be found outside the section whose heading indicates that topic.

All claims and the abstract, as filed, are part of the specification. The abstract is provided for convenience and for compliance with patent office requirements; it is not a substitute for the claims and does not govern claim interpretation in the event of any apparent conflict with other parts of the specification. Similarly, the summary is provided for convenience and does not govern in the event of any conflict with the claims or with other parts of the specification. Claim interpretation shall be made in view of the specification as understood by one of skill in the art; innovators are not required to recite every nuance within the claims themselves as though no other disclosure was provided herein.

To the extent any term used herein implicates or otherwise refers to an industry standard, and to the extent that applicable law requires identification of a particular version of such as standard, this disclosure shall be understood to refer to the most recent version of that standard which has been published in at least draft form (final form takes precedence if more recent) as of the earliest priority date of the present disclosure under applicable patent law.

While exemplary embodiments have been shown in the drawings and described above, it will be apparent to those of ordinary skill in the art that numerous modifications can be made without departing from the principles and concepts set forth in the claims, and that such modifications need not encompass an entire abstract concept. Although the subject matter is described in language specific to structural features and/or procedural acts, it is to be understood that the subject matter defined in the appended claims is not necessarily limited to the specific technical features or acts described above the claims. It is not necessary for every means or aspect or technical effect identified in a given definition or example to be present or to be utilized in every embodiment. Rather, the specific features and acts and effects described are disclosed as examples for consideration when implementing the claims.

All changes which fall short of enveloping an entire abstract idea but come within the meaning and range of equivalency of the claims are to be embraced within their scope to the full extent permitted by law.

What is claimed is:

1. A software development computing system, comprising:
a digital memory;
a software development tool having a graphical user interface; and
a processor in operable communication with the digital memory, the processor configured to perform software development context history (SDCH) operations including: receiving an edit operation via the graphical user interface, automatically and proactively identifying an edited source code produced by the edit operation, automatically and proactively generating an SDCH data retrieval data structure specifying data which extends beyond the edited source code and also extends beyond any human-made comment in the edited source code, and automatically and proactively associating the SDCH data with the edited source code using the SDCH data retrieval data structure.

2. The computing system of claim 1, wherein the system is configured to store the SDCH data in at least one of the following formats:
a metadata format external to any comment in the edited source code; or
a comment format within a system-generated source code comment in the edited source code.

3. The computing system of claim 1, wherein the system further comprises a version-controlled repository, and wherein the system is configured to store the SDCH data and the edited source code coordinated together in the version-controlled repository.

4. The computing system of claim 1, wherein the SDCH data includes data representing or indicating at least one of the following:
an origin of the edited source code; or
a natural language description of the edited source code.

5. A software development method performed by a software development tool having a graphical user interface, the method comprising:
getting via the graphical user interface an identification of an edited source code block;
retrieving a software development context history (SDCH) data by using an SDCH item that is associated with the edited source code block, the SDCH data being additional to the edited source code block and also being additional to any human-made comment that is located in the edited source code block or is located within five lines or two hundred characters or both of any part of the edited source code block; and
displaying the SDCH data in the graphical user interface.

6. The method of claim 5, further comprising ascertaining that the SDCH data is enabled for display prior to displaying the SDCH data in the graphical user interface, and wherein the ascertaining is based on at least one of:
matching a search parameter to the SDCH data or to a category designation of the SDCH data;
comparing a code review filter to the SDCH data or to a category designation of the SDCH data; or
comparing an SDCH data display setting to the SDCH data or to a category designation of the SDCH data.

7. The method of claim 5, wherein displaying the SDCH data comprises showing or identifying at least one of:
an assertion that the edited source code block resulted at least in part from a paste;
a particular source that at least a part of the edited source code block was copied from before being pasted in;
a particular internet source that at least a part of the edited source code block was copied from before being pasted in;
a particular repository source that at least a part of the edited source code block was copied from before being pasted in;
a query submitted to a source of at least a part of the edited source code block;
an assertion that at least a part of the edited source code block resulted from a find-replace;
an assertion that at least a part of the edited source code block resulted from a refactor;
an assertion that at least a part of the edited source code block resulted from a specified kind of refactor; or
a particular refactoring mechanism that produced at least a part of the edited source code block.

8. The method of claim 5, wherein displaying the SDCH data comprises showing at least one of:
an assertion that a copy of at least a part of the edited source code block is used elsewhere; or
an assertion that code deemed similar to at least a part of the edited source code block is used elsewhere.

9. The method of claim 5, further comprising performing a targeted code history rollback which includes at least:
getting a non-version-control search parameter which specifies neither a particular time nor a particular source code control version; and
matching the SDCH data to the non-version-control search parameter.

10. The method of claim 5, wherein the method displays data of an SDCH set inside an editor development tool which is displaying a source code that includes the edited source code block, the SDCH set including at least one SDCH item, the displayed data of the SDCH set indicating at least two of the following software item lifecycle events:
an origin of the edited source code block;
a bug fix associated with the edited source code block;
a security upgrade associated with the edited source code block;
a testing result associated with the edited source code block;
a performance result associated with the edited source code block; or
a log entry associated with an execution of an executable code that was derived from the edited source code block.

11. The method of claim 5, wherein displaying the SDCH data includes listing a software libraries combination which includes at least two software libraries that the edited source code block utilizes, and specifying at least one of:
another usage of the software libraries combination; or
a natural language description of the software libraries combination.

12. The method of claim 5, wherein displaying the SDCH data occurs in response to at least one of the following display triggers:
receiving an edit operation which is directed at the edited source code block; or
recognizing a testing failure result associated with the edited source code block.

13. The method of claim 5, wherein displaying the SDCH data comprises showing or identifying at least one of:
an assertion that at least a part of the edited source code block was suggested by an autocompletion mechanism;
a particular autocompletion mechanism that produced at least a part of the edited source code block;
an assertion that at least a part of the edited source code block was suggested by a code generation mechanism;
a particular code generation mechanism that produced at least a part of the edited source code block item;
an assertion that at least a part of the edited source code block resulted from providing a specified input to a code generation mechanism, the assertion displayed together with a copy of the specified input; or
an assertion that at least a part of the edited source code block resulted from providing a specified natural language description as input to a code generation mechanism, the assertion displayed together with a copy of the specified natural language description.

14. The method of claim 5, wherein displaying the SDCH data comprises showing or identifying at least one of:
an assertion that at least a part of the edited source code block resulted from a static analysis mechanism;
an assertion that at least a part of the edited source code block resulted from a specified static analysis result;
a particular static analysis mechanism that produced at least a part of the edited source code block;
a particular editor command that produced at least a part of the edited source code block;
an assertion that at least a part of the edited source code block resulted from a specified code review; or
an assertion that at least a part of the edited source code block resulted from a specified testing result.

15. The method of claim 5, wherein displaying the SDCH data comprises showing or identifying at least one of:
an assertion that at least a part of the edited source code block was produced without any pasting;
an assertion that at least a part of the edited source code block was produced without any find-replace;
an assertion that at least a part of the edited source code block was produced without any refactoring,
an assertion that at least a part of the edited source code block was produced without any autocompletion;
an assertion that at least a part of the edited source code block was produced without any code generation; or
an assertion that at least a part of the edited source code block was produced without any static analysis.

16. A computer-readable storage device configured with data and instructions which upon execution by a processor cause a computing system to perform a software development method, the method comprising:
receiving an edit operation via a software development tool user interface;
identifying a source code block targeted by the edit operation, the source code block being in a source code file;
generating a software development context history (SDCH) data retrieval data structure specifying an SDCH data which extends beyond the source code block and also extends beyond any human-made comment in the source code file;
associating the SDCH data with the source code block using the SDCH data retrieval data structure;
retrieving the SDCH data using the SDCH data retrieval data structure; and
displaying the SDCH data in the software development tool user interface.

17. The computer-readable storage device of claim 16, wherein displaying the SDCH data comprises showing or identifying at least one of:
a particular internet source that at least a part of the source code block was copied from into the source code file; or
a query submitted to a source of at least a part of the source code block, the source external to the source code file.

18. The computer-readable storage device of claim 16, wherein displaying the SDCH data comprises showing or identifying at least one of:
an assertion that at least a part of the source code block resulted from a specified static analysis result; or
an assertion that at least a part of the source code block resulted from a specified testing result.

19. The computer-readable storage device of claim 16, wherein displaying the SDCH data comprises showing or identifying at least one of:
an assertion that at least a part of the source code block resulted from a specified kind of refactor; or
an assertion that at least a part of the source code block resulted from a specified code review remark.

20. The computer-readable storage device of claim 16, wherein displaying the SDCH data comprises showing or identifying at least one of:
an assertion that at least a part of the source code block resulted from a refactor; or
an assertion that at least a part of the source code block resulted from providing a specified input to a code generation mechanism, the assertion displayed together with a copy of the specified input.
